(19) United States
(12) Patent Application Publication
(10) Pub. No.: US 2025/0297037 A1
(43) Pub. Date: Sep. 25, 2025

(54) METHODS FOR PREPARING TUNICATE DERIVED NANOCRYSTALLINE CELLULOSE, AND USES THEREOF

(71) Applicant: UNIVERSITY OF PRINCE EDWARD ISLAND, Charlottetown (CA)

(72) Inventors: Bishnu ACHARYA, Saskatoon (CA); Matthew J. DUNLOP, Charlottetown (CA)

(21) Appl. No.: 18/682,717

(22) PCT Filed: Nov. 5, 2021
(86) PCT No.: PCT/CA2021/051583

§ 371 Date: Feb. 9, 2024

Related U.S. Application Data
(60) Provisional application No. 63/231,548, filed on Aug. 10, 2021.

(51) Int. Cl. C08B 15/08; C09D 101/02; C09J 197/02

(52) U.S. Cl. CPC C08B 15/08; C09D 101/02; C09J 197/02

(57) ABSTRACT

A process is described for preparation of tunicate derived CNCs (T-CNCs) which exhibit a high aspect ratio, increased crystallinity and superior thermal properties compared to wood pulp derived CNCs (W-CNCs). The process enables scalable isolation of T-CNCs from tunicates, and a solution to the challenge invasive tunicates pose to aquaculture communities.

### CROSS-REFERENCE TO RELATED APPLICATIONS

The present application is a national phase of International Application No. PCT/CA2021/051583 filed Nov. 5, 2021, which claims the benefit of priority from U.S. Provisional Patent Application No. 63/231,548 filed on Aug. 10, 2021, the contents of both of which are hereby incorporated by reference.

### FIELD OF THE INVENTION

The present invention generally relates to methods for preparing tunicate derived nanocrystalline cellulose, and uses of the nanocrystalline cellulose materials derived from these methods.

### BACKGROUND OF THE INVENTION

As the global community attempts to shift away from petroleum based non-renewable materials, the scalable production of sustainable and renewable alternatives has become increasingly important. Among the most promising of these sustainable and renewable alternatives are cellulose nanomaterials, which represent a family of cellulosic materials comprised exclusively of cellulose arranged in either highly crystalline, discrete cellulose nanocrystals (CNCs), or semicrystalline, interconnected cellulose nanofibrils (CNFs).

A growing demand for CNCs (and CNFs) globally is currently being driven by a plethora of emerging and established applications for this green nanomaterial including in sensing, catalysis, nanofiltration, tissue engineering, and numerous others.

At the lab scale, CNCs can be isolated from a wide variety of natural resources including various plants, bacteria, algae and tunicates. Given the abundance and biodiversity of cellulose sources, it is intuitive that CNCs display subtle differences resulting from the natural source and method of isolation, which have been well summarized in prior reports. However, regardless of the source, to meaningfully contribute to the growing global CNC market, these CNC isolation processes must be transitioned from small volume lab scale (g/day) processing to larger volume (kg/day) and (tons/day) commercial scale processing. Today, the only cellulose source material currently available at commercial scale is that derived from plants, specifically wood (W-CNCs). These are typically isolated at low kg/day rates. Smaller lab scale production of bacterial CNCs⁴⁰ and tunicate CNCs^{9,18} do exist, but these are generally prepared for limited research applications.

There is accordingly a need for improved processes for producing CNCs that are sufficiently scalable to produce these materials at larger scale.

### SUMMARY OF THE INVENTION

Described herein are methods for extracting nanocrystalline cellulose from invasive tunicates, including but not limited to Ciona intestinalis (vase tunicate) and Styela clava (club tunicate). The methodology involves the steps of collecting/harvesting the tunicates, pre-processing via an alkaline oxygen-limiting environment, and post-processing via hydrolysis and filtration.

The nanocrystalline cellulose materials derived from these methods can be utilized, in certain embodiments, as a base or principle component in a diverse array of downstream material applications, including but not limited to applications in biomedicine, bio-based packaging and construction materials.

In embodiments, the described methods produce nanocrystalline cellulose materials which are extremely strong, with high modulus and low density when compared to similar natural and synthetic base materials.

Accordingly, there is provided herein a method for preparing tunicate derived nanocrystalline cellulose (tCNC), comprising:
collection of or providing raw tunicate biomaterial;
fibrillating the separated tunic to form a crude tunic pulp;
deproteinating the crude tunic pulp under alkaline conditions with heating to solubilize said proteins, and then bleaching the solubilized proteins;
separating the deproteinated tunic pulp from reaction solution by hot filtering;
adjusting pH of the filtered deproteinated tunic pulp to acid conditions, to produce a solid deproteinated and bleached tunic pulp, optionally with additional washing and hot filtering;
fibrillating the deproteinated and bleached tunic pulp to produce a wet cellulose pulp base material;
and hydrolyzing the wet cellulose pulp base material with a strong acid to produce said t-CNC.

In certain non limiting embodiments of the described method, the method further comprises a step of separating the internal organs from the tunic of the raw tunicate biomaterial prior to fibrillating. Without wishing to be limiting, it is envisioned that the separating step comprises mechanically pressing the raw tunicate biomaterial using a pressing device (e.g. using counter rotating rollers or a screw press) to loosen the tunic-organ connection within the tunicates.

In further non limiting embodiments, the step of separating internal organs from the tunic of the raw tunicate biomaterial may comprise: pressing the raw tunicate biomaterial prior to fibrillating using a pressing device (e.g. by passing through counter rotating rollers or a screw press) to rupture the tunic and loosen the connection with organ material; and optionally physically washing the pressed tunicate biomaterial; stirring the pressed tunicate biomaterial in water (e.g. using a spiral/ribbon mixer, screw press or submersible pump) for a time and at a speed effective to separate the tunic form the internal organs; screening the stirred, pressed tunicate biomaterial to remove the water and produce separated tunic and organ components; and collecting the tunic.

In further non limiting embodiments of the described method, the separated tunic is fibrillated by mechanical treatment, for example, using a mill or other such device commonly used. For example, a grinding mill, a garburator or a woodchipper could be used, and preferably a grinding mill.

In further non limiting embodiments of the described method, the crude tunic pulp is deproteinated using an alkaline solution of NaOH, KOH or a mixture thereof, and heating at from 50-75° C., preferably about 65° C., for 1 to 24 hours, preferably about 12 hours, followed by said bleaching. In exemplary embodiments, the alkaline solution may comprise about 1.0-10.0 wt %, or about 3.0-7.0 wt %, or about 4.0-5.0 wt % NaOH, KOH or a mixture thereof. In addition, bleaching of the deproteinated pulp may for example be carried out by adding a bleach solution containing NaOCl with e.g. between 5 and 15% active chlorine, and acetic acid e.g. at a concentration between 5 wt. % and 97 wt. %.

In further non limiting embodiments of the described method, the hot filtering comprises filtering the deproteinated tunic pulp one or more times over a fiberglass screen mesh reinforced with a metal screen mesh.

In further non limiting embodiments of the described method, the acid conditions are at or below pH 3.0, preferably at or below pH 2.0.

In further non limiting embodiments of the described method, the pH is adjusted using a strong acid. For example, the strong acid may be sulfuric acid or hydrochloric acid, and the concentration of the strong acid may be at a concentration e.g. of about 1-10 wt. % acid. In preferred embodiments, the strong acid is sulfuric acid.

In further non limiting embodiments of the described method, the fibrillating of the deproteinated and bleached tunic pulp is carried out using grinding mill or a garburator, preferably a grinding mill, to produce a fine pulp.

In further non limiting embodiments of the described method, the fine pulp is a homogenous material where individual fibers can no longer be visually distinguished in the tunicate cellulose pulp.

In further non limiting embodiments of the described method, the hydrolyzing comprises adding the strong acid to the wet cellulose pulp base material, mixing, quenching to neutralize the strong acid, allowing the resulting t-CNC to settle in solution, washing the settled solid t-CNC material, and then concentrating the washed T-CNCs to a final product.

Also provided herein are tunicate derived nanocrystalline cellulose (tCNC) prepared according to the method described in any of the above paragraphs, or as further described herein.

Also provided are coating materials comprising a tunicate derived nanocrystalline cellulose (tCNC) prepared according to the method described in any of the above paragraphs, or as further described herein.

There is also provided an adhesive comprising a tunicate derived nanocrystalline cellulose (tCNC) prepared according to the method of described in any of the above paragraphs, or as further described herein.

Packaging materials are also provided comprising a tunicate derived nanocrystalline cellulose (tCNC) prepared according to the method of described in any of the above paragraphs, or as further described herein.

Uses of the nanocrystalline cellulose so prepared are also provided, including but not limited to uses as a coating or adhesive in biomedicine, packaging and/or construction materials.

Other and further aspects and advantages of the described method will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The aspects, features and advantages of the invention will become more readily apparent from the following description, reference being made to the accompanying drawings in which:

FIG. 1 is a flow chart for isolation of T-CNCs from tunicates.

FIG. 2 shows the aspect ratio distribution of W-CNC and T-CNC (A) and representative W-CNC and T-CNC micrographs (B).

FIG. 3 shows steady shear viscosity of 1 wt % T-CNC and W-CNC suspensions (A) steady shear and (B) small amplitude oscillatory (SAOS) data for the T-CNC suspension.

FIG. 4 shows experimental X-ray diffractograms of lyophilized T-CNC and W-CNC.

FIG. 5 shows Raman spectra of wood and tunicate CNCs.

FIG. 6 shows TGA thermograms of lyophilized CNCs in air (a) and an inert nitrogen (b).

FIG. 7 is a flow chart showing the processing of raw tunicates to T-CNC.

FIG. 8 is a flow chart showing the processing of raw tunicates to tunic pulp.

FIG. 9 is a graph showing pH vs percent abundance for NaOCl solution.

FIG. 10 illustrates tunicate soap production, application, and dissemination.

FIG. 11 is a flow chart showing the processing of tunic pulp to deproteinated tunic pulp.

FIG. 12 is a flow chart showing the processing of deproteinated tunic pulp to bleached tunic pulp.

FIG. 13 is a flow chart showing the processing of bleached tunic pulp to T-CNC products.

FIG. 14 is a flow diagram illustrating the mass flow of 100 kg Tunicate to T-CNC.

FIG. 15 is a flow diagram illustrating the energy flow of 100 kg Tunicate to T-CNC.

FIG. 16 illustrates crossed-polarized images of suspensions of A) as prepared W-CNCs (5 wt %), B) lyophilized W-CNCs (5 wt %), C) redispersed W-CNCs (5 wt %), D) as prepared T-CNCs (1 wt %), E) lyophilized T-CNCs (1 wt %), F) redispersed T-CNCs (1 wt %). Images were taken between crossed linear polarizers and all solutions display shear birefringence.

FIG. 17 is a graph illustrating measured EDS data for dried tunic powder.

FIG. 18 is a schematic of tangential (cross) flow compared to dead-end filtration.

FIG. 19 illustrates graphs showing the length (top) and width (bottom) distributions of W-CNC and T-CNCs.

FIG. 20 illustrates overlaid FTIR spectra with calculated Lateral Order Index (LOI) and Total Crystallinity Index (TCI) of prepared CNCs.

FIG. 21 illustrates DTGA thermograms of lyophilized CNCs in an oxidizing compressed air (a) and an inert nitrogen environment (b).

### DETAILED DESCRIPTION

Described herein are methods for preparing tunicate derived nanocrystalline cellulose, and uses of the nanocrystalline cellulose materials derived from these methods. The methods described involve collection of tunicates, pre-processing, and post processing resulting in T-CNC. Other valuable co-products are also obtained during the process, including but not limited to tunicate derived proteins.

Tunicates are marine animals which contain highly pure cellulose in their tunic, the unique leather-like epidermis of the animal from which its name is derived. This ‘tunicin’ cellulose may be hydrolyzed with appropriate procedures to yield T-CNCs, which possess among the highest aspect ratio and crystallinity of all known CNC sources. Current commercial W-CNCs have an aspect ratio of 10-20 and tend to display lower crystallinity (60-80%) than T-CNCs, which possess an aspect ratio of 50-100 and crystallinity commonly exceeding 90%. The potential advantages of a widely available CNC source, possessing both high crystallinity and high aspect ratio, are broad in scope. However, T-CNCs are only isolated at lab scale currently and, as a result, most recent research focuses on commercially available W-CNCs.

As a further incentive, tunicates are an invasive nuisance species causing economic challenges for the local aquaculture community on Prince Edward Island. The present invention therefore provides a means to directly address the growing problems invasive tunicates cause, turning nuisance tunicate species into a valuable resource, utilized to the benefit of the local aquaculture community and economy.

Higher aspect ratio CNCs lead to improved stress transfer in composites, reduced concentrations necessary for gelation, and enhanced viscosity modification. Moreover, T-CNCs can be used in combination with W-CNCs to form hybrid CNC mixtures which possess broad and tailorable aspect ratio distributions. These hybrid CNC mixtures lead to the enhancement of all in-plane and some out-of-plane mechanical properties in hybrid CNC films. Such hybrid mixtures can, in certain embodiments, enhance stiffness in polymer composites compared to individual CNC sources.

Previous attempts to isolate T-CNCs first involve the removal of non-cellulose tunicate components via manual separation, alkaline and bleaching pretreatments. This is then followed by treatment of the purified cellulose to yield CNCs with varying surface chemistries. Non-cellulose components are generally removed using ether moderate temperature, standard pressure, chemical treatments; or by using more mild chemical treatments combined with increased temperatures and pressures.

In prior work, the inventors utilized a three step hydrothermal treatment to isolate and compare T-CNCs from numerous tunicate species at lab scale. While highly pure T-CNCs were isolated in a reasonable yield by this method; the necessity of a sealed pressure vessel at elevated temperatures over multiple processing steps limited the scalability of this process. For these reasons, chemical pretreatments performed at moderate temperatures and standard pressure were selected for the presently described method, to develop more scalable methods for tunicate pretreatment.

Once the purified tunicate cellulose is obtained, it can be surface modified using numerous approaches, such as but not limited to 2,2,6,6-tetramethylpiperidine-1-oxyl (TEMPO) mediated oxidation and sulfuric acid hydrolysis, or left unmodified using hydrochloric acid hydrolysis. The most common of these treatments for both wood and tunicate derived CNCs is sulfuric acid hydrolysis. Under appropriate conditions, this results in the nearly complete hydrolysis of amorphous cellulose content to yield CNCs, and the concurrent grafting of negatively charged sulfate groups to the CNC surface. These charged groups reduce interactions between neighboring CNCs, limiting the agglomeration and flocculation of CNC suspensions and allowing for their dispersion in a wider range of solvents.

The high aspect ratio of T-CNCs make them more susceptible to agglomeration and flocculation than other comparatively low aspect ratio W-CNC sources. This motivated the inventors to design the described large-scale T-CNC isolation process to yield sulfated T-CNCs.

After hydrolysis is complete, the acidic CNC solution is typically quenched followed by salt removal and concentration of the aqueous CNC suspension. In lab scale CNC isolation, a combination of conventional filtration techniques, centrifugation, and dialysis are commonly employed to obtain a purified and concentrated CNC product. These techniques are limited in scalability, challenging to replicate or optimize, and often result in significant loss and/or contamination due to multiple small-volume product transfers. This has led to the adoption of highly scalable tangential flow filtration (TFF) systems. In TFF, the feed flows tangential to the membrane, leading to a continual defouling of the membrane surface by the feed components. This allows for the large scale diafiltration and subsequent concentration of CNCs in a single system, leading to increased efficiency and reduced loss from product transfers. In this study, TFF was utilized to both purify and concentrate the isolated T-CNCs, demonstrating that this scalable technique can be applied to T-CNCs.

The primary challenges of scaling up T-CNC isolation historically have been either a lack of available tunicates, difficulties in the large-scale harvesting of tunicates and the limited amount of available literature surrounding T-CNC isolation, at any scale. Some of the challenges associated with T-CNC isolation may be mitigated by both unique local factors and by the growing global effects of climate change. Recently, tunicates have been causing great concern to aquaculture industries in the Maritime Provinces of Atlantic Canada.

In the inventors' previous work, they highlighted how the mussel industry in Prince Edward Island (PEI) has been threatened by growing costs, reduced mussel harvests and the need to constantly apply anti-fouling treatments to fishing gear as a result of this tunicate infestation. Through Dynamic Energy Budget modelling, a recent study predicted that invasive tunicates may reduce mussel production by more than 20%²¹⁷. This is highly relevant to the local economy as PEI harvests over 80% of all blue mussels sold in Canada, while also selling product internationally^{218,219}. In PEI alone, there are four different tunicate species, all of which are invasive and of foreign origin^{108,215-217}. As the climate warms, the conditions under which tunicates thrive become more prevalent, leading to increased tunicate densities and growing challenges for local aquaculture communities^{109,217,220-222}.

However, it is demonstrated that: 1) the scalable harvesting of tunicates is possible and 2) high quality T-CNC can be isolated from these local invasive tunicates. The commercial scale harvesting of tunicates could directly address the challenges of high tunicate density in local waterways. Easing the burden on members of the aquaculture community by harvesting tunicates for scalable T-CNC production may lead to a shift in the perception of invasive tunicates from a destructive nuisance species, to that of an abundant and available resource to be harvested and utilized¹⁰⁹. Local waters surrounding PEI, along with similar marine environments worldwide with dense tunicate populations, serve as accessible sources of tunicate feedstock, with potential for scalable T-CNC isolation²²³.

In the following Examples, the commercial scale extraction of high aspect ratio T-CNCs from the abundant feedstock of invasive tunicates on PEI is described and optimized and the inventors' experiences during the various steps, from harvesting to T-CNC isolation, are discussed. Various characterizations are performed to better understand the behavior and challenges of preparation as well as the attributes of the final T-CNCs. Experiences from large-scale preparation of W-CNCs using established protocols as well as the ultimate characteristics of W-CNCs and other nanocelluloses are described for comparison.

### EXAMPLES

### Preparation of a Tunicate-Derived Cellulose Feedstock

### Harvesting

The starting material for the pilot-scale production of W-CNCs is a high-purity commercial cellulose pulp prepared by well-established wood pulping protocols. Obviously, the preparation of a similar cellulose feedstock from tunicates is necessarily a very different process. To prepare a relatively large quantity of tunicate cellulose feedstock, we began by manually harvesting approximately 20 kg of invasive Styela clava tunicates from waterways surrounding PEI. Manual harvesting is a viable process to collect commercial scale quantities of tunicates. In fact, it is estimated that over a million pounds of Styela clava (wet weight) are cultivated and harvested annually from waters around South Korea, where they are consumed as a seafood delicacy known locally as “mideuduck”^{107,225,226}. These have primarily been manual tunicate harvesting methods similar to those employed here. Although we posit efficient automated processes may lower harvesting costs. Recently, Ocean Bergen AS implemented an automated approach for harvesting tunicates from Norwegian waters to extract protein for animal feed 223.

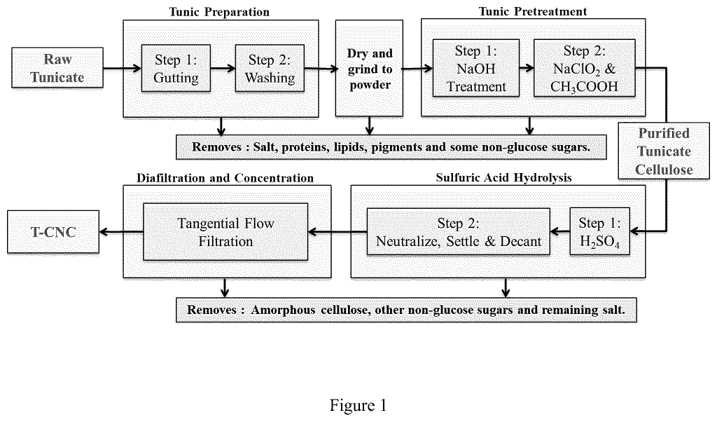

The processing of the tunicates after harvesting is schematically shown in FIG. 1. Important aspects are discussed herein, and a more detailed description of the T-CNC and W-CNC isolation process is provided in Supplemental Materials Section S1.

### Tunic Preparation

Once harvested, the cellulose-containing tunics were manually separated from the protein-rich internal organs. We are currently investigating more economically viable approaches including automated tunic separation and a biorefinery-type approach which utilizes the entire tunicate as a process input. The manually prepared tunics used here were washed, dried and ground as described in Supplemental Materials Section S1. While others have used the internal organs to prepare animal feed 106 or to ferment bioethanol 39, we chose to focus on T-CNC isolation and simply disposed of the internal organs. The use of such byproducts is left for future work. Generally, one half of a tunicates weight is its tunic, although this varies with tunicate species, environmental factors and life cycle stage. We found that our 20 kg of Styela clava tunicates harvested from PEI waters resulted in an estimated 10 kg of tunic, which were 90% water, yielding approximately 1 kg of dried tunic powder.

### Tunic Pretreatment

To isolate T-CNCs from this tunic powder, the cellulose must be purified, and the non-cellulose components removed to prepare a high cellulose feedstock for acid hydrolysis. To accomplish this, the tunic powder was shipped to the Forest Products Laboratory where it was further processed by alkaline deproteination treatments and bleaching following the protocols described by van den Berg et al., with modifications as described in Supplemental Materials Section S1. The overall yield for the deproteination and bleaching steps was 31%, comparable to the yields reported in Table 1 for similar processes at lab scale. The final bleached material was used as the feedstock for preparing T-CNCs by acid hydrolysis.

TABLE 1
Other reports of tunicate cellulose purification strategies and respective yields.

| | | | Pretreatment | |
|---|---|---|---|---|
| Tunicate Feedstock | Deproteination | Bleaching | Yield (%)* | Reference |
| Salpa fusiformis | Pronase in buffer | NaOH reflux | N/A | ²²⁷ |
| Styela clava | KOH | NaClO/CH₃COOH | N/A | ^{7, 136, 145, 207} |
| Halocynthia roretzi | KOH | NaClO/CH₃COOH | N/A | ²²⁸ |
| Halocynthia | NaOH | NaClO₂ | N/A | ²¹⁰ |
| papillosa | | | | |
| Halocynthia roretzi | NaOH | NaClO₂ | N/A | ²²⁹ |
| Halocynthia roretzi | NaOH | H₂O₂ | 20 | ^{211, 230, 231} |
| Drasche | | | | |
| Styela clava | NaOH | NaClO₂/CH₃COOH | 31 | This Work |

| | | | |
|---|---|---|---|
| Styela clava | Three step hydrothermal process | 40 | ⁴⁹ |
| Ciona intestinalis | Prehydrolysis (H₂SO₄) | 30 | ⁴⁹ |
| Ciona intestinalis | Kraft Cooking (NaOH/Na₂S) | 12 | ^{9, 224} |
| Ascidia sp. | Bleaching (NaClO) | 3 | ^{9, 224} |
| Cynthia roretzi | Step 1 & 2: 180° C. \| 2 h | 30 | ¹¹¹ |
| Styela plicata | Step 3: 75° C. \| 1 h | 24 | ^{9, 224} |
| Halocynthia roretzi | | 21 | ^{9, 224} |

*Approximate values | N/A = Not Reported.

According to Zhao and Li, generally tunic possesses a 50:50 weight ratio of carbohydrates to proteins, where between 75% and 95% of the carbohydrate fraction is glucose, and of the glucose fraction, between 50% and 75% is cellulose⁹. Although their work focuses on four different tunicate species, we feel that their general conclusions are applicable to our processing. Therefore, this suggests that the 1 kg of dried tunic powder prepared for this work likely possesses only 19-36% cellulose. Given this estimate, coupled with the findings reported in Table 14, our overall yield of 31% for the deproteination and bleaching steps seems reasonable.

While the additional non-cellulose tunicate components present a challenge when isolating T-CNCs, these additional components have intrinsic value and may be recoverable. Although not the focus of this study, we suggest that additional value-added product streams, including protein 232 and heavy metal recovery (see Supplemental Materials Section S2)²³³⁻²³⁶, may be feasible if tunicates are processed to T-CNC in a biorefinery-type approach. This requires thoroughly understanding the components of waste streams generated in T-CNC isolation and determining their recoverability, an active area of investigation in our group.

### CNC Preparation

Wood derived W-CNCs are prepared from high purity cellulose wood pulp (≥97% cellulose) in the Nanocellulose Pilot Plant at the Forest Product Laboratory using standard protocols³⁸. The main steps in the process are: 1) sulfuric acid hydrolysis, 2) diafiltration to remove by-products, and 3) concentration of the resulting aqueous CNC suspension. Tunicate derived T-CNCs were prepared similarly, albeit on a smaller scale, and with necessary changes to accommodate differences in the source materials. Our experiences during the various steps of the T-CNC preparation are discussed below along with relevant comparisons to W-CNC processing and proposed changes to protocols that may improve the process.

### Sulfuric Acid Hydrolysis

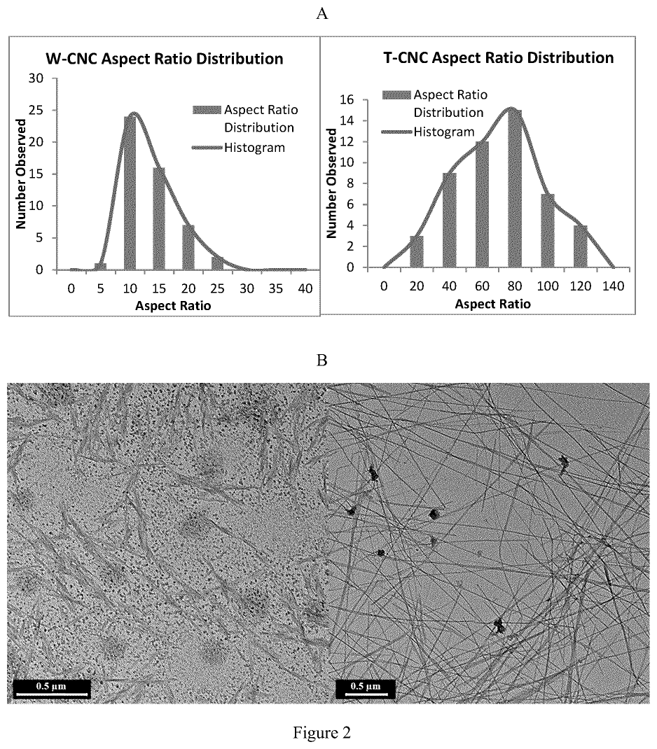

Hydrolysis of the tunicate cellulose was accomplished using 64% H₂SO₄ for 2 hours with additional details described in Supplemental Materials Section S1. The hydrolysis yield was 42% for T-CNCs, compared to 50% for the optimized W-CNC isolation, resulting in aspect ratios of 65 and 12 respectively (FIGS. 2A and B, Section S4 and Section S5 of Supplemental Materials). For additional context, we have summarized the resulting aspect ratios and yields reported in numerous studies where similar cellulose sources and processing conditions were utilized to isolate CNCs at differing scales (Table 15).

TABLE 2
Other reports of CNC isolation with varying
production scale and hydrolysis conditions.

| Cellulose | Production | H₂S0₄ | CNC Aspect | Hydrolysis | |
|---|---|---|---|---|---|
| Source | Scale | Hydrolysis | Ratio* | Yield (%)* | Reference |
| MCC ^{#} | Lab | (64%, 2 h) | 15 | 30% | ²³⁷ |
| Cotton | Lab | (65%, 30 min) | 12 | N/A | ¹² |
| Cotton | Lab | (60%, 4 h) | 15 | N/A | ²³¹ |
| Wood | Lab | (64%, 25 min) | 28 | 33% | ^{3, 113} |
| Wood | Lab | (64%, 2 h) | 23 | N/A | ⁷ |
| Wood | Pilot | (64%, 1.5 h) | 12 | 50% | This Work & ³⁸ |
| Wood | Commercial | (64%, N/A) | 20 | N/A | ^{203, 238} |
| Tunicate | Lab | (60%, 1.5 h) | 50 | N/A | ²⁰⁷ |
| Tunicate | Lab | (65%, 2 h) | 72 | N/A | ²³⁰ |
| Tunicate | Lab | (60%, 32 h) | 70 | N/A | ²³¹ |
| Tunicate | Lab | (50%, 20 h) | 63 | N/A | ²²⁹ |
| Tunicate | Lab | (48%, 13 h) | 70 | N/A | ¹² |
| Tunicate | Lab | (48%, 3 h) | 100 | N/A | ⁷ |
| Tunicate | Lab | (55%, 20 min) | 35 | 30% | ²²⁴ |
| Tunicate | Lab | (50%, 4.5 h) | 80 | 50% | ²³⁹ |
| Tunicate | Pre-pilot | (64%, 2 h) | 65 | 42% | This Work |

*Approximate values | N/A = Not Reported | ^{#} = Microcrystalline Cellulose (MCC)

In many reports, information such as yield, and precise processing conditions unfortunately are omitted. However, we note that the T-CNCs prepared here display properties consistent with previous T-CNCs isolated at laboratory scale. Indicating that the impressive properties attributed to T-CNCs can, as pioneered in the development of large-scale W-CNC isolation, be preserved when T-CNC isolation is scaled up. At this time, replicate experiments and concurrent process optimization of T-CNC isolation at this scale remain future areas of study. Also, as discussed later, some material was lost during diafiltration, which adversely affected the T-CNC yield. Therefore, with further improvement of protocols, the T-CNC yield could very well approach that of the W-CNCs.

### Diafiltration and Concentration

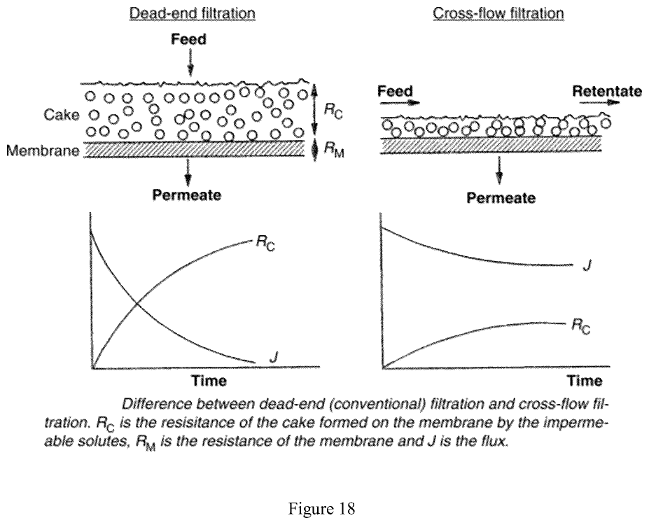

Following hydrolysis, the reaction is quenched and neutralized with aqueous NaOH. The resulting highly saline suspension leads to the association and settling of CNCs. Most hydrolysis by-products could then be removed by decanting the supernatant, adding deionized water, again allowing CNCs to settle and repeating the process. Eventually as salinity decreased the CNCs began to suspend rather than settle, and a tubular ultrafiltration unit was used to complete by-product removal by tangential (cross) flow filtration (TFF)³⁸. TFF reduces filter cake formation by creating turbulent flow, which improves flux rate compared to conventional dead-end filtration (See FIG. 18). As filtrate is removed, additional water is added, and the hydrolysis byproducts are flushed from the CNCs in a process referred to as diafiltration. Unfortunately, some residual, aggregated tunicate derivatives obstructed the circulation pump during diafiltration of T-CNCs, suggesting that improvements in our processing protocols are warranted. The suspension was filtered and centrifuged using a large, industrial centrifuge to remove the aggregated material (See Section S1 and S4 of Supplemental Materials). The diafiltration process was then completed. This additional product loss almost certainly contributed to the lower yield of the T-CNCs when compared to the W-CNCs.

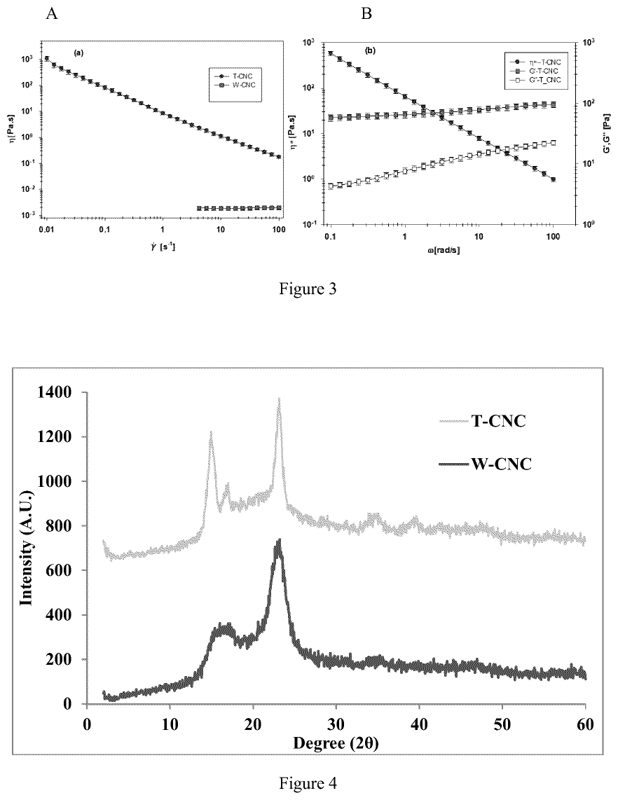

The make-up water was then shut off to concentrate the CNC suspension until its viscosity increase inhibited flow through the membranes tubes, after which the system was back flushed to yield the concentrated CNCs. The CNC suspension viscosity is primarily governed by the aspect ratio of the CNCs and the CNC concentration, where the salinity of the suspension is assumed to be consistent since both W-CNCs and T-CNCs are neutralized prior to filtration. FIG. 3 presents rheological properties of the 1 wt % W-CNC and T-CNC suspensions in water. The viscosity of the T-CNC suspension in the same concentration (1 wt %) is considerably higher than that of the W-CNC suspension (FIG. 3A). This is attributed largely to the higher aspect ratio of T-CNCs of 65 compared to about 15 for W-CNCs. For CNC suspensions, a shear-thinning behavior with increasing shear rate is expected due to the orientation of fibers. For the 1 wt % W-CNC suspension, a low, constant viscosity of less than 2 mPa·s is observed. This is in line with the results obtained by Lenfant et al. for a similar W-CNC suspension 240. At this concentration of low aspect nanoparticles, Brownian motion prevents the orientation of the particles under flow 240. In the case of the 1 wt % T-CNC suspension, the shear-thinning behavior is attributed to a gel-like structure formed by this suspension of large aspect ratio nanoparticles. With increasing shear rate, this structure is broken down explaining the decreasing viscosity although particle orientation could be partly responsible of the shear thinning. The presence of the gel structure is confirmed by the linear storage and loss moduli data of the T-CNC suspension presented in FIG. 3B. We observe a gel-like or viscoelastic solid-like behavior where the storage modulus (G′), is much greater than the loss modulus (G″) and both moduli are relatively independent of frequency 241. Gelation of the T-CNC suspension at low concentration is due to its high aspect ratio and this behavior was observed previously at much higher concentration for W-CNC aqueous suspensions (˜10 wt %) 240

As observed previously by others^{178,242,243}, high aspect ratio CNC suspensions display considerably higher viscosity values than lower aspect ratio CNC suspensions. In our case, the maximum concentration of the high aspect ratio T-CNC was 1.3 wt %. This is far below the 10 wt % achievable with lower aspect ratio W-CNCs, but similar to that found for TEMPO pretreated wood-derived cellulose nanofibrils 244.

### Further Processing Protocol Steps and Embodiments

Further embodiments of the described methods may include, from extraction of the tunicates to isolation of the T-CNC, keeping the cellulose containing material wet as drying should be avoided to prevent hornification. Hornification results from the formation of hydrogen bonded networks during drying that are only partially reversible. Here, we initially dried the tunic and between each process step the yield was determined by drying the intermediate product. This may have led to a compounding of the hornification of cellulosic material, resulting in reduced efficacy of chemical treatments and a lower process yield. If drying is necessary, lyophilization is preferable to air or oven drying to lessen the effect of hornification. Traces of color were still observed after the bleaching step, which we attempted to remedy with additional bleaching after acid hydrolysis. To obtain whiter and cleaner materials, alternating between acid chlorite bleaching and alkaline extraction may be a beneficial procedural improvement. The level of calcium in the final T-CNC product is quite high at 0.054 wt %, as typical levels observed in W-CNC processing are less than 0.002 wt % (See Section S2 of Supplemental Materials). We expect that the source is likely the tunicates' natural calcium-rich environment. The T-CNC hydrolysis is highly acidic and when the reaction was neutralized, it likely caused association of the negatively charged CNC sulfate groups with calcium cations. The calcium level may be reduced by the addition of an acid wash after bleaching, by decanting the acidic T-CNC solution after hydrolysis but before neutralization, or with suitable chelation treatments. After the hydrolysis and neutralization, some aggregates were observed which interfered with subsequent ultrafiltration and purification steps. Simple screening for these aggregates prior to filtration may improve ultrafiltration efficacy. With scaling, it may also be advantageous to replace the large-scale centrifuging, if it is still found necessary after other improvements, with mechanical homogenization to improve yield, processing efficiency and overall consistency of the T-CNC product. Given the very different size distributions of the two types of CNCs, it may be possible to increase the T-CNC concentration efficiency by optimizing the pore size of the ultrafiltration membranes.

### CNC Properties

Once the T-CNCs and W-CNCs were prepared and their morphologies understood, we compared their crystallinity and thermal stabilities while contrasting our findings with past reports. What follows is our assessment of the results and how the properties of the obtained T-CNCs compare to that of W-CNCs prepared by an optimized process.

### Crystallinity

We assessed the overall structural order of as produced CNCs utilizing two complimentary techniques: XRD and Raman. A summary of our findings and those reported by others for CNCs prepared by similar procedures is displayed in Table 16 and FIGS. 32 and 33. As described in Section S6 of Supplemental Materials, FTIR spectroscopy was also performed to determine the Lateral Order Index (LOI) and Total Crystallinity Index (TCI) of the isolated T-CNCs and W-CNCs.

TABLE 32
Steady shear viscosity of 1 wt % T-CNC and W-CNC suspensions
(a) steady shear and (b) small amplitude oscillatory
(SAOS) data for the T-CNC suspension.

| Cellulose | | | 380- | 93- | |
|---|---|---|---|---|---|
| source | XRD* | NMR | Raman | Raman | Reference |
| MCC | 84 | NA | 77 | 68 | ^{237, 246} |
| Cotton | 92 | 75 | 77 | 68 | ^{229, 246} |
| Wood | 80-89, 90, 72 | 60 | 56 | 46 | ^{113, 156, 246} |
| Tunicate | 91, 95 | 80, 94 | 70 | 93 | ^{7, 246} |
| Wood | 66, | NA | 56 | 46 | This work |
| Tunicate | 75 | NA | 68 | 96 | This work |

NA is not available | *For wood, wide range attributable to varying methods used to calculate crystallinity.

### XRD

The overall structural order of the prepared CNCs was further assessed by calculating their percent crystallinity from the background-corrected experimental diffractograms in FIG. 4, consistent with our prior work 60. In this way, the T-CNC was determined to be 75% crystalline whereas the W-CNCs were 66% crystalline. Evidence of uniplanarity is observed in the T-CNC diffractograms by comparing the relative intensities of the 11̅0 and 110 reflections. Elazzouzi-Hafraoui et al. attributed this to the rectangular cross-section of T-CNCs compared to the square cross-section of W-CNCs, where the longer plane of the rectangular T-CNC axis gives rise to enhanced 11̅0 reflection intensity. However, this has also been reported to result from CNC orientation induced either from drying kinetics or incomplete hydrolysis¹². Our XRD samples were prepared by freezing aqueous suspensions of dilute CNC (˜0.5 wt %) in liquid N₂ followed by freeze-drying. Therefore, we expect that if orientation of the CNCs is contributing to the enhanced 11̅0 reflection intensity, it is more likely a result of incomplete hydrolysis than drying induced orientation. This is supported by TEM results which indicate unusually wide T-CNC crystallites (˜20 nm), which has been attributed to small bundles of CNCs arising from hornification or other processes¹⁷⁶. We have contrasted our findings with past reports in Table 16 and provide further assessment of experimental diffractograms in Section S7 of Supplemental Materials. We note that a wide range of values are reported for W-CNCs and T-CNCs, which result from the diverse methods used to calculate crystallinity from XRD diffractograms reported in literature^{13,116}. To provide a more comprehensive understanding of the relative crystallinities of our CNCs, we utilized Raman spectroscopy.

### Raman

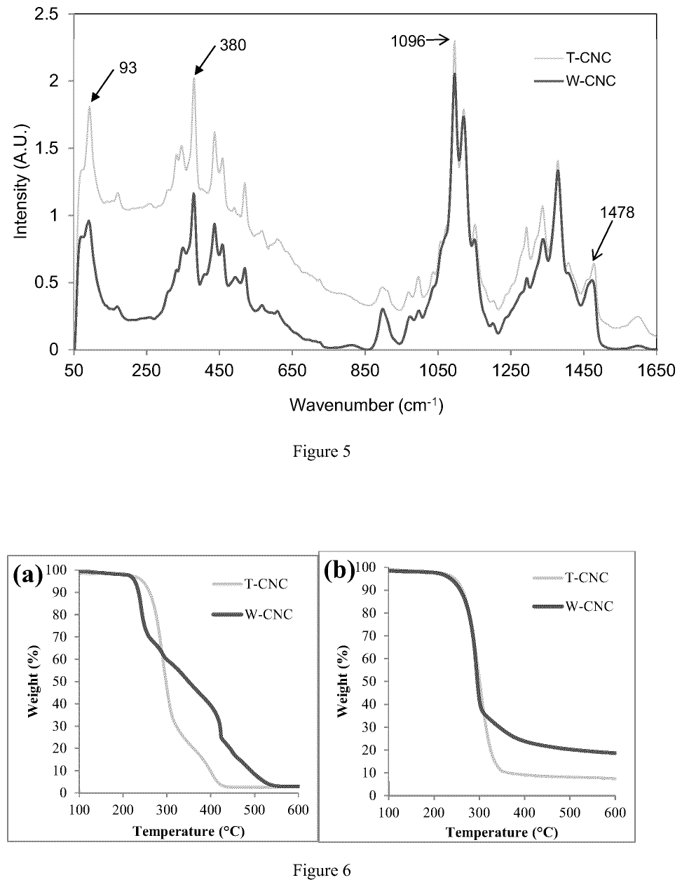

Raman crystallinities of the wood and tunicate CNCs were determined using two methods—380-Raman (Agarwal et al. 2010; 2013) and 93-Raman (Agarwal et al. 2018), and the values are reported in Table 16. The methods are based, respectively, on the band intensity ratios 380/1096 cm⁻¹ and 93/1096 cm⁻¹ in the Raman spectra of the CNCs visible in FIG. 5. The Raman crystallinity data in Table 16 indicated that in both the Raman methods, compared to the crystallinity of wood CNCs the crystallinity of tunicate CNCs was significantly higher. For 380-Raman and 93-Raman, the crystallinity was higher by 21% and 109%, respectively. Although it's not clear why the two methods differed so significantly with respect to the increase, the increases supported the observation based on XRD that T-CNCs were significantly more crystalline compared to W-CNCs. The highly crystalline nature of the T-CNCs mean that they are stronger and less sensitive to moisture than W-CNCs in various applications.

### Thermal Stability

To understand the thermal stability of the T-CNCs isolated in this work and how it compares to W-CNCs, we performed TGA in both an oxidizing (air) and an inert (nitrogen) environment. The resulting thermograms and their derivatives were obtained and compared with those of W-CNC analyzed in the same manner. As visualized in FIG. 6 and further shown below and in FIG. 21, the isolated T-CNCs are more thermally stable than W-CNCs in an oxidizing environment.

The onset of thermal degradation for W-CNCs is clearly lower (FIG. 6, a) than that of the T-CNCs in air. However, the trend in an inert environment (FIG. 6, b) is less apparent. In air, both CNC materials displayed ˜3% ash content. However, in inert nitrogen there is an increase in the ash content of the W-CNCs (19%) and, to a lesser extent, the T-CNC (8%). This indicates that W-CNCs have a higher content of nitrogen-stable components or thermal degradation products 247. We posit that this may be linked to the plethora of ocean derived elements (see Section S2 of Supplemental Materials) present in the T-CNCs but not found in W-CNCs. We have summarized some of the sparsely reported thermal properties of T-CNCs prepared by similar acid hydrolysis procedures in Table 17 and contrasted these with W-CNCs. We assess that the observed differences in thermal stability result primarily from previously discussed variations in crystallinity, as well as the relative sulfur content and the surface area of wood and tunicate derived CNCs which are discussed below.

TABLE 43
Reported oxidative thermal properties of various
CNCs prepared by H₂S0₄ hydrolysis.

| Cellulose | Onset | Inflection | H₂S0₄ | |
|---|---|---|---|---|
| Source | Temperature* | Point* | Hydrolysis | Reference |
| Wood | 235 | 253 | (64%, 2 h) | ²³⁷ |
| Wood | 210 | 240, 421 | (64%, 1.5 h) | This Work |
| | | | | & ³⁸ |
| Wood | 255 | 275 | (64%, N/A) | ²³⁸ |
| Tunicate | 180 | N/A | (50%, 3 h) | ²⁴⁸ |
| Tunicate | 180 | N/A | (50%, 4.5 h) | ²³⁹ |
| Tunicate | 106# | 128# | (60%, 20 min) | ²⁴⁹ |
| Tunicate | 290 | N/A | (55%, 1 h) | ²⁰⁸ |
| Tunicate | 190 | 200 | (55%, 20 min) | ²²⁴ |
| Tunicate | 225 | 291 | (64%, 2 h) | This Work |

*Approximate values | N/A—Not Reported | #Measured in an inert environment.

### Perspective and Outlook

By processing roughly 20 kg of invasive tunicates to H₂SO₄ hydrolyzed T-CNCs, this work accomplishes the largest scale isolation of T-CNCs reported to date. Learning from the pilot scale development of W-CNCs, we isolated T-CNCs using scalable techniques, with reasonable yield, and of similar properties to those reported for T-CNCs isolated at laboratory scale by others. The overall yield of our pretreatment (31%) and acid hydrolysis (42%) of the tunic powder was within the range of values reported for laboratory scale tunicate to T-CNC processes. Overall, the yield of T-CNCs from our process was 12.2% based on the dry weight of the tunic powder and T-CNCs isolated therefrom. Experimentally determined aspect ratios, crystallinity, and some thermal properties of the T-CNCs exceeded those of W-CNCs, as expected; and were similar to those found for T-CNCs prepared at laboratory scale by others. Replicate trials that implement the numerous potential process improvements described here would likely lead to a considerable increase in yield and quality of T-CNCs at this scale, and we feel that the proposed improvements themselves are scalable in nature. Other procedures for T-CNC isolation may be scalable and modified from literature in a likewise manner. These may yield T-CNCs of similar or improved properties based on the process conditions, tunicate source and degree of process optimization.

We posit that the commercial scale isolation of tunicate derived CNC is feasible and that the unique properties of these T-CNCs, which complement the growing global utilization of nanocellulose materials, justifies this pursuit. We chose an invasive species negatively affecting local aquaculture communities in PEI and across Atlantic Canada as the T-CNC source. This allows us to demonstrate the unique conditions that currently exist on PEI, which mitigate the historic challenges of tunicate harvesting and T-CNC isolation at commercial scale. These conditions are not limited to Atlantic Canada and entities around the globe are currently harvesting tunicates at commercial scale for their proteinaceous components. Regardless of the driving force, tunicates will ultimately be considered and perhaps utilized as a large-scale source of numerous value-added products, including their unique animal-derived high aspect ratio cellulose, for commercial T-CNC isolation. This study lays tangible groundwork towards that goal, directly demonstrating the feasibility and results of kilogram scale tunicates to T-CNC processing, and promoting the widespread utilization of both invasive and native tunicates to produce useful and sustainable materials for the benefit of our growing global community.

### Methods

A more detailed description of the T-CNC and W-CNC isolation process is provided in Section S1 Supplemental Materials. What follows are general descriptions of the equipment and techniques utilized to obtain the reported experimental data and is complimented further in the Supplementary Information.

### Elemental Analysis

The sulfur, sodium and calcium content of the prepared CNCs was determined using Inductively Coupled Plasma Optical Emission Spectroscopy (ICP-OES) (Ultima II, Horiba Jobin-Yvon, Edison, NJ, USA) using previously developed protocols¹⁵⁵.

The qualitative elemental composition of the dried tunic powder used to prepare the T-CNCs was investigated with a JEOL JSM6400 Digital SEM, using the equipped EDX (Genesis) Energy Dispersive X-ray system. Digital X-ray maps were obtained from powdered samples which were mounted to carbon tape and carbon coated for conductivity prior to imaging.

### Transmission Electron Microscopy (TEM)

To assess the morphology of the T-CNC and W-CNC, transmission electron microscopy (TEM) micrographs were obtained on a JEOL 2011 STEM instrument. Dilute (0.001 wt %) colloidal suspensions were cast onto etched copper coated grids and air-dried prior to imaging. The average length, width and aspect ratio were calculated from at least 50 measurements from 5-10 representative micrographs of each sample using Image J software.

### Fourier-Transform Infrared Spectrometry (FTIR)

Attenuated total reflectance Fourier transform infrared spectrometry (ATR-FTIR) was performed to understand the functional groups present, screen for impurities and to calculate the Lateral Order Index (LOI) and Total Crystallinity Index (TCI) of the isolated T-CNCs and W-CNCs. A Bruker Alpha FTIR spectrometer (Alpha-P) was utilized with OPUS software, 32 scans were averaged against background scans to yield the reported spectra in the range of 4000 to 500 cm 1. The measured transmittance values were converted to absorbance and the magnitude of the absorbance at 2900, 1430, 1375 and 897 cm⁻¹ was used to determine LOI and TCI.

### Thermogravimetric Analysis (TGA)

Thermal properties were assessed with the aid of Thermogravimetric analysis (TGA) which yielded thermal decomposition profiles for T-NCC and W-CNCs, as well as their first derivative with respect to weight (DTGA) thermograms. Experiments were performed on a TA Instruments TGA Q500 under an oxidizing atmosphere (60 mL/min compressed air, 40 mL/min nitrogen) from room temperature to 700° C., using a heating rate of 10° C./min. Inert atmosphere thermograms were obtained by first purging the sealed sample chamber for 30 minutes with a 100 mL/min nitrogen flow rate, after which the sample was heated at 10° C./min to 700° C. under nitrogen.

### X-Ray Diffraction (XRD)

X-ray diffraction (XRD) was performed to assess the crystallinity of the isolated T-CNC and W-CNC used in this work. Aqueous CNC samples (0.5 wt %) were flash frozen in liquid nitrogen prior to lyophilization to obtain the dry CNC sample for analysis. The utilized Bruker AXS D8 Advance instrument was equipped with a graphite monochromator, variable divergence slit, variable anti-scatter slit and a scintillation detector. Cu (Ka) was the radiation source used (k=1.542 A°) and the measurements were performed on glass slides with a double-sided scotch tape adhesive, in air, at room temperature, from 2-60° (20).

### Raman Spectroscopy

For estimations of crystallinity by Raman spectroscopy methods (380-Raman and 93-Raman²⁵⁰⁻²⁵²), sample pellets were prepared with a pellet-forming die. Approximately 100 mg of T-CNCs and W-CNCs were used for making pellets. The CNCs were analyzed with a Bruker (Billerica, MA) MultiRam equipped with a 1064-nm 1,000 mW continuous wave (CW) diode pumped Nd:YAG laser. Spectra were recorded from 2,048 co-added scans using 600 mW laser excitation, as reported previously²⁵³.

In all cases, Bruker OPUS 7.2 software was used to process the spectral data which involved normalization, selection of a spectral region, background correction, and band integration. Background correction was performed using a 64 points OPUS “rubberband option”. For plotting purposes, the spectra were converted to ASCII format and exported to Excel.

CNCs crystallinity was estimated using two Raman methods—380-Raman^{250,251} and 93-Raman²⁵². The following two equations were used to estimate these crystallinities.

$${CrI}_{380 - Raman} = \frac{( ( \frac{{I}_{380} / {I}_{1096} ) - 0.0286 )}{0.0065} ) + 2.0212 )}{0.8222} \qquad ( 1 )$$

$${CrI}_{93 - Raman} = \frac{( \frac{{I}_{93}}{{I}_{1096}} ) - 0.0182}{0.0029} \qquad ( 2 )$$

### Rheometry

A stress-controlled Anton Paar rheometer (MCR 502) was used to carry out the rheological measurements at 25° C. Couette and double-Couette flow geometries were used for different samples. The region of linear viscoelasticity was first determined by performing strain-sweep tests. The viscoelastic behavior of the suspensions was determined from frequency sweep tests in the linear regime. The steady shear test was performed from low to high shear rate. The reproducibility of all data was investigated by repeating the tests three times. To eliminate the history effect, all samples were pre-sheared at shear of 100 s⁻¹ for 5 min followed by 30 min rest prior to all subsequent tests. To assure homogeneity of the suspensions and eliminate aging effect all the samples were ultrasonicated using a Sonics & Materials VCX500 probe, operating at 20 kHz, at a power of 60 W and energy of 10,000 J/g_{CNC}, operated in pulses with suspensions placed in an ice bath to avoid overheating.

Larger Scale Isolation of Tunicate CNC [100 kg]

Lessons learned processing the 25 kg of raw tunicates to CNC described in above are applied in this example, where an improved process which isolates CNC from 100 kg of raw tunicate input is described. More attention is paid here to the large-scale collection and preprocessing of tunicates. This larger process, in which the cellulose is never dried, demonstrates clear progress towards directly addressing the tunicate problem on PEI.

In order to further demonstrate that T-CNC can be isolated from local invasive tunicates at large scale on PEI, we have processed 100 kg batches of locally sourced tunicates to T-CNC. This section describes a working iteration of this process which is based on our experience gained from lab scale T-CNC isolation at UPEI (˜20 g of raw tunicate input) and from larger scale T-CNC isolation at the Forest Product Laboratory (˜25 kg of raw tunicate input). Notably, this chapter describes the collection of raw tunicates and the necessary preprocessing steps which have been developed to facilitate the large-scale harvesting and standardization of the tunicate input. To our best knowledge this work represents the largest scale on which T-CNC has ever been isolated from tunicates.

### Process Overview

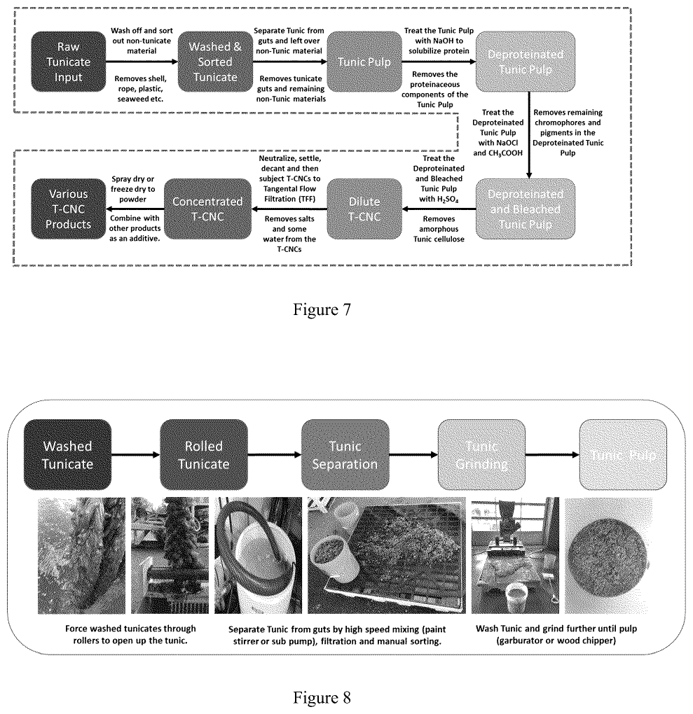

Based on our prior experiences processing local invasive tunicates to T-CNC we felt that it makes the most sense to divide the process into the general steps outlined in the FIG. 7. The following sections describe the general methodology used to isolate T-CNCs from local invasive tunicates.

### Raw Tunicate Input

The first step in converting invasive tunicates to T-CNC is the collection of the tunicates, a process which results in the collection of significant non-tunicate material as a consequence of the tunicates natural environment and the method of tunicate collection. We collect our tunicates manually from fishing gear owned by Prince Edward Aqua Farms, however an automated process is under development. The tunicates were harvested at both Malpeque Bay and Montaque Bay locations, between the months of July to November. The process for washing this raw tunicate input and separating the tunicate from the non-tunicate material is currently accomplished manually, however the throughput is quite high (>50 kg/hour) due to the obvious visual differences between the tunicate and non-tunicate components. Examples of material removed in this manner are crabs, mussels, fishing gear (rope etc.), general waste (plastic packaging, construction material, etc.), and many other non-tunicate materials. The quantity of non-tunicate material in each batch of raw tunicate input, after manual sorting and washing with 50 L of fresh water is estimated at 20%, therefore 100 kg of raw tunicate input yields 80 kg of tunicate after non-tunicate removal and washing.

### Tunicate to Tunic Pulp

After standardizing the tunicate input by cleaning and removing all visible contaminants, the next major step is to separate the protein rich internal organs from the cellulose rich tunic. At lab scale this is accomplished manually using a scalpel, however this is not a very efficient technique at larger scale. Therefore, we developed a more scalable technique for separating tunic from the organs using a low-cost combination of off the shelf and manual techniques described in the flow chart shown in FIG. 8.

The tunicates were first squished by counter rotating rollers whose distance from each other was less than a quarter inch, the forces experienced by the tunicate when between the rollers ruptured the tunic and loosened the tunic-organ connection within the tunicates. These weakened tunicates are then immersed in a 200 L polyethylene barrel which is filled with fresh water to 100 L total volume. A standard spiral type of paint stirrer with ribbon design is mounted to a drill and is immersed into the aqueous dispersion, then the drill is turned on for 10 minutes. As an alternative method, a ½ HP submersible sewage pump equipped with an 8-foot 2 inch diameter hose can be used to accomplish the same effect by circulating the entire solution for a similar period of time. The rotating paint stirrer (or pump) causes an aggressive mixing process which loosens and eventually separates the tunic form the internal organs in the aqueous medium. The entire contents of the barrel are then drained through a large, elevated screen which removes the water and results in clearly separated tunic and organ components on the screen. The screen is than manually cleaned with tunic and organs collected separately. At this point the tunic has been separated from the internal organs but the tunic is still largely intact. To make the tunic a more consistent input for later processing we fibrillate the tunic further to form a crude tunic pulp. Initial trials accomplished the tunic fibrillation to tunic pulp using a household garburator (a sink mounted waste disposal unit), however we also demonstrated this using a 13 HP woodchipper. Both processes produced a suitable tunic pulp for downstream processing however the woodchipper is a more robust and durable choice for this quantity of tunic input. The fibrillated tunic pulp is then collected and used as an input for the next step. A typical yield of wet tunic from a given quantity of wet tunicate is roughly 50%, therefore the 80 kg of tunicate input to this step results in 40 kg of tunic with the remainder being internal organ.

### Tunic Pulp to Deproteinated Tunic Pulp

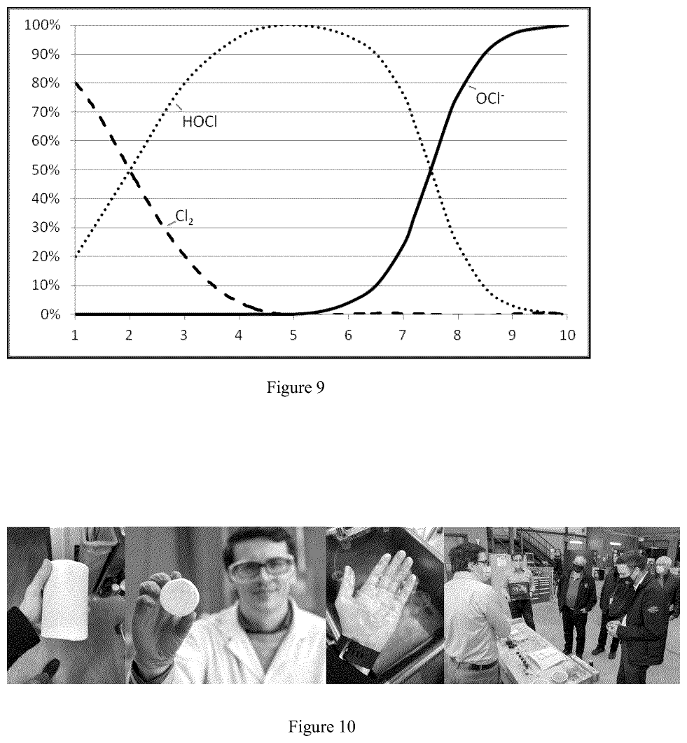

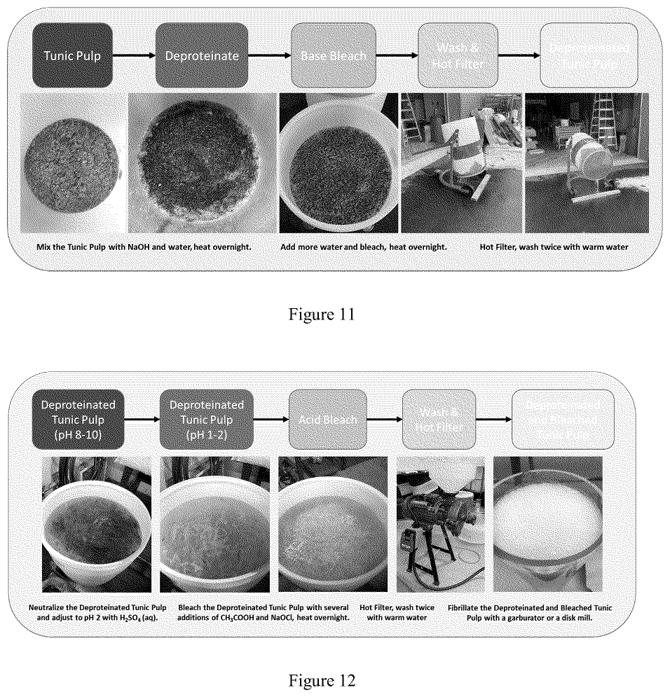

The fibrillated tunic pulp is then combined with NaOH in a 200 L polyethylene barrel with 2 kg of NaOH and enough water to reach 40 L of total volume. The barrel, containing an alkaline solution 4.5 wt % NaOH, is then heated using a blanket heater to 65° C. and left overnight (12 h). This process solubilizes the remaining proteins, lipids and some non-glucose sugars. At this point a base-bleach (chlorite bleaching under basic conditions) is performed by adding a 4 L bottle of household bleach (Giant Tiger, 5% active chlorine). The volume of the barrel is then immediately increased to 100 L with warm DI water, the blanket heater is set to 65° C. and the reaction is left overnight (12 h). This base bleaching makes use of the differing species which common household bleach forms under alkaline conditions compared to acidic conditions. As seen in FIG. 9, which plots pH vs percent abundance, a pH of 2 indicates that the equilibrium favors chlorine; the active agent in acidic bleaching (the next process step). Between a pH 2 and 7.4 hypochlorous acid predominates, which we do not expect to form given the highly basic nature of this step (>pH 10) and the highly acidic nature of the next step (<pH 2). However above pH 7.4, such as in the current case (4.5 wt % NaOH), hypochlorite predominates. We have found that the use of this ‘base bleaching’ step produces a significantly less colored product, which helps to ensure a pristine white product from the acidic bleaching which follows. After the base bleach, the product is separated from the reaction solution by a process we call hot filtering. In this process a custom-made filter comprised of a standard vinyl-coated fiberglass window screen reinforced with a metal screen mesh is mounted to the top of a 200 L polyethylene barrel and attached like a lid using the barrels standard ring clamp. The entire barrel containing warm (65° C.) contents is then lifted and inverted using a commercial barrel tipper. The inverted barrel is placed above a chemical spill container. In this way the solids are preserved in the barrel due to the custom screen and the hot reaction solution is collected separately in the chemical spill container. The alkaline reaction solution can then be collected, neutralized, and disposed of in a controlled manner. We have also demonstrated that this solution can be used in combination with household cooking grease to prepare a ‘tunicate soap’ by making use of the same saponification reactions used to make hard soaps (FIG. 10) since the ancient Roman times.

While this additional non-cellulose value-added product is not the direct focus of this report, we were able to use this tunicate soap throughout the remaining stages of tunicate processing. It was primarily used as a hand soap and as a cleaner for the processing equipment (plastic barrels, etc.); but it was also used as a way to demonstrate, particularly to the general public, that additional non-cellulose value-added products are possible with this tunicate to CNC process. In this way tunicate soap has allowed us to improve the sustainability of our processing and to connect more effectively with the general public and the policy members who represent them.

Once the deproteinated tunic pulp has been hot filtered from the reaction solution the barrel is flipped to face up and 100 L of warm water is added with manual agitation, once added the barrel is inverted and the product is again hot filtered. One more addition of 100 L is added before the final hot filtration (FIG. 11), the product of which is used in the next step.

### Deproteinated Tunic Pulp to Bleached Tunic Pulp

The deproteinated tunic pulp prepared in the previous step is placed in a 200 L polyethylene barrel, the total volume of the barrel containing the filtered deproteinated tunic pulp is adjusted to 40 L by adding warm water. The pH is lowered to below 2 by adding 1 L of 98 wt. % sulfuric acid with the warm water and manually agitating for ˜5 minutes. A blanket heater is applied to the barrel and set to 65° C., after which point a ‘bleaching charge’ of 250 mL of NaOCl (15% active chlorine) and 50 mL of 97% CH₃COOH is added to begin the acidic bleaching process, and the reaction is left overnight (12 h). As an alternative, we have demonstrated that the 250 mL of NaOCl (15% active chlorine) and 50 mL of 97% CH₃COOH bleaching charge can be supplemented by using 1 L of household bleach (Giant Tiger, 5% active chlorine) and 1 L of household vinegar (5% CH₃COOH) instead.

The next day a second bleaching charge is added with manual agitation, and, at one-hour intervals, two additional bleaching charges are added with manual agitation. The barrel is allowed to settle for one hour following the addition of the final bleaching charge. After this point the solution is hot filtered, and the liquid and solid components are separated as in the previous deproteination step. The liquid components can be reused for neutralizing basic solutions or low-quality bleaching; however it is primarily disposed of at this point. Future work may reveal more uses for the liquid product of this step.

The solid component is the deproteinated and bleached tunic pulp, which is then washed and hot filtered with two additions of 100 L of warm water, as done in the previous step. The deproteinated and bleached tunic pulp is then fibrillated, using either a 5-inch diameter dish grinding mill or a household garburator, to a fine pulp (FIG. 12). Where a fine pulp is defined here as a homogenous material where individual fibers can no longer be visually distinguished in the tunicate cellulose pulp. In smaller scale lab work we accomplished this fibrillation step in a laboratory blender, and we posit that future larger scale tunicate to CNC processing would necessitate the use of disk mill or a similar process capable of continuous high throughput fibrillation. After deproteinating, bleaching and fibrillating the tunic pulp, what remains is a homogenous, never dried, tunicate cellulose pulp which has numerous potential applications. To produce the tunicate CNCs which are the subject of this research, the tunicate cellulose pulp is subject to the following process.

### Bleached Tunic Pulp to T-CNC Products

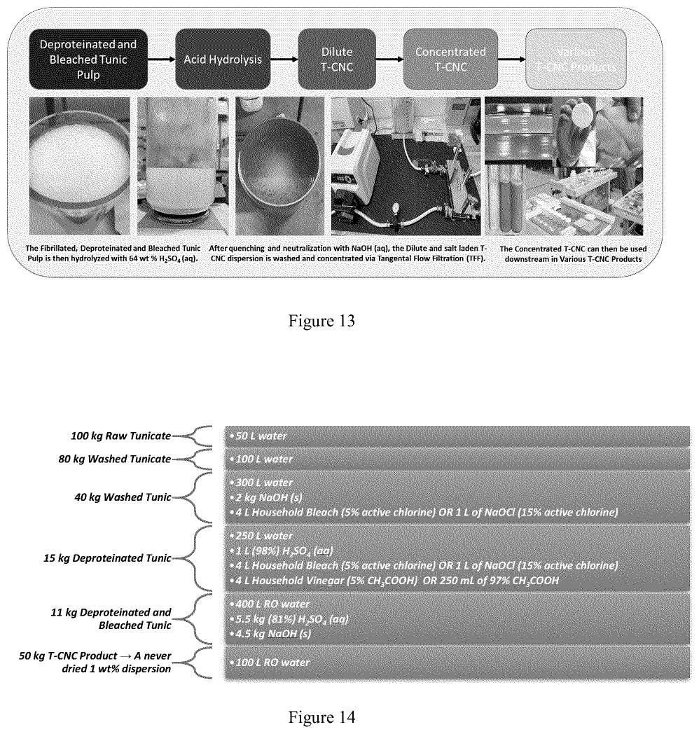

The never dried, deproteinated, and bleached tunic pulp is then hydrolyzed to tunicate CNCs which can be used in various downstream T-CNC products. The acid hydrolysis utilizes 45% H₂SO₄ (aq.) and is performed at a solid to liquid ratio of 1:10, premeasured acid is added to the wet cellulose pulp of known solid content and the dispersion is vigorously mixed for 2 hours at 45° C. Due to safety concerns in handling large volumes of concentrated acid in a confined laboratory setting, we hydrolyzed an aliquot of the tunicate cellulose pulp prepared in the prior step and have used the product of this smaller hydrolysis in subsequent steps. An aliquot of 150 grams of never dried, deproteinated, and bleached tunic pulp was used in this hydrolysis step. This pulp was assumed to be entirely tunicate cellulose, and the solid content of the pulp was determined gravimetrically to be 10 wt % (15 grams of dry tunicate cellulose). The tunicate cellulose pulp was then adjusted to 20 wt % by evaporative drying and the resulting 75 grams of cellulose pulp was combined with 75 grams of 81 wt % H₂SO₄ (aq). After mixing the aliquot reaction for 2 hours at 45° C., the reaction was quench by pouring it into 2.5 L of reverse osmosis (RO) water. A mixture containing 60 grams of NaOH, and 2.5 L of RO water was then slowly added to the quenched aliquot reaction to neutralize the acid. This highly saline dispersion was then allowed to settle overnight, after which 4 L of supernatant was decanted from the settled and saline tunicate CNC dispersion. The remaining 1 L containing the saline aggregated tunicate CNCs was then placed in a tangential flow filtration (TFF) system, and an additional 10 L of RO water was passed through the TFF system to wash out residual salts. The T-CNC product was then concentrated to 670 grams of 1.0 wt % T-CNC, equivalent to 6.7 grams of dry T-CNC, a 45% yield of T-CNC based on the dry weight of the hydrolysis input (FIG. 13). The yield of the entire tunicate to CNC process is then extrapolated from the yield and quantities determined and utilized in the small-scale hydrolysis and subsequent steps. It is notable that recently Designer Energy Ltd. disclosed what they claim to be a ‘waste free’ process for the sulfuric acid hydrolysis of cellulose pulp to produce CNC and additional value added products²⁵⁴. Some of the techniques reported therein, and related techniques, may in the future be adapted to the hydrolysis of tunicate cellulose pulp^{37,38,40,254-258}.

After hydrolysis, the acidic reaction is quenched by diluting it with RO water (volume goes from 200 mL to 2.5 L), and neutralizing with dilute ˜5% NaOH (aq) to a final volume of ˜5 L. This highly saline dispersion is left overnight (12 h) which allows the settling of the T-CNC, about 4 L of the saline solution is removed by decanting the supernatant from the settled dispersion. The remaining 1 L containing the salty T-CNCs was diluted to 5 L total volume with RO water and additional salt was washed out by passing an additional 10 L of RO water through the dispersion using a TFF system. By continuing to run the TFF system without adding additional RO water, we were then able to then concentrate the washed T-CNCs to a gel like final product with 1.1 wt % T-CNCs. These CNCs can then be used in various downstream T-CNC applications.

### Mass Flow of Process

The general mass flow of the tunicate to T-CNC process is displayed in FIG. 14. All the yields are experimentally derived and have been practically demonstrated, however it should be noted that the final acid hydrolysis of the tunicate cellulose and the subsequent TFF washing, and T-CNC concentration were performed on an aliquot of the tunicate cellulose. Therefore, the overall process yields for the hydrolysis, the TFF washing and T-CNC concentration is extrapolated from these smaller scale results.

The total process for isolating tunicate CNC from 100 kg batches of raw PEI tunicates consumes 700 L of fresh water, 500 L of RO water, 6.5 kg of NaOH, 8 L Household Bleach (5% active chlorine) OR 2 L of NaOCl (15% active chlorine), 4 L Household Vinegar (5% CH₃COOH) OR 250 mL of 97% CH₃COOH, and ˜4.5 kg of (98%) H₂SO₄ (aq).

### Energy Flow of Process

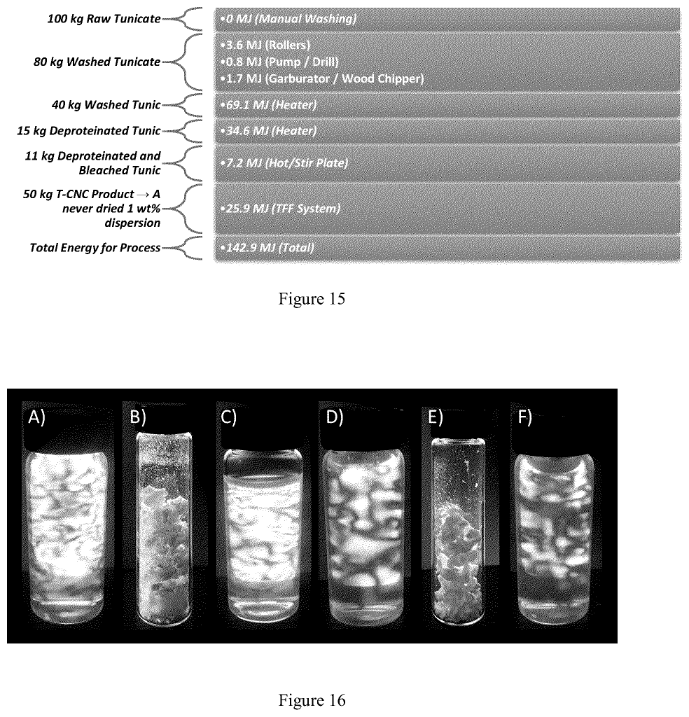

The energy flow for the process of isolating tunicate CNC from 100 kg batches of PEI tunicates is also provided (FIG. 15). Energy contributions for each process step are determined from the power consumption (Watts) of the necessary equipment and the duration that it is used in each process step.

The total energy used in this process was calculated from a summation of the energy used in each process step, to be 142.9 MJ. Future work could focus on understanding the energy consumption of various process steps and optimize the energy use.

### Summary of Process Improvements

The major process improvements implemented in the 100 kg batch process for isolating T-CNC from local invasive tunicates are as follows:

Never dry the material (all the way from tunicate to T-CNC).

Developed a process to efficiently wash 100 kg batches of tunicates.

Developed a mechanical process to separate kilograms of tunic from tunicate guts.

Utilized 200 L plastic barrels and a hot filtering technique in the processing.

Utilized household equipment in process such as a grinding mill, or alternatively a garburator or wood chipper.

Implemented a ‘base bleaching’ step to produce a less colored product.

Used household vinegar and bleach rather than lab grade CH₃COOH and NaOCl.

Demonstrated the use of TFF to collect T-CNCs on PEI for the first time.

Together these improvements and the additional findings herein related to the isolation of T-CNC from invasive PEI tunicates, represent significant new knowledge creation in this area and bring us closer than ever to directly addressing the challenges local tunicates pose to PEI aquaculture.

### A Note on Club Vs Vase Tunicates

Both club and vase tunicates were used throughout this work to isolate T-CNCs. While our initial lab scale T-CNC isolation made use of both species and compared the subtle differences between the CNCs isolated from both species; it was decided that it is better to focus on the more significant differences found between T-CNCs and commercially available W-CNCs. Therefore, the focus of the research regarding T-CNC isolation was to develop a scalable process which could be used to isolated T-CNCs from both club and vase tunicates. The focus was on increasing the scale of the process rather than comparing the respective yields and properties of the T-CNC isolated from both species at the same process scale. This is what justified the decision to use only club tunicates in the 25 kg batch processing, and to compare the resulting T-CNC with commercially available W-CNCs. Due to this decision the research was focused towards developing a working process for isolating T-CNC from 100 kg batches of tunicates, rather than spent on a comparative analysis of the properties and yield of T-CNC isolated from both species at the 25 kg batch scale. Notably, focusing on the comparison of T-CNCs to W-CNCs also provides useful context for the findings herein regarding hybrid W-CNC and T-CNC combinations.

Due to the support of Prince Edward Aqua Farms, we were able to procure 100 kg of vase and club tunicates to be used in our 100 kg T-CNC isolation process. However, the numbers reported herein are only for the process which used 100 kg of vase tunicates as a process input. The reason that numbers for club tunicates are unavailable at this time is that the author used the 100 kg of procured club tunicates as testing material to develop the numerous process improvements described in the previous sections. As a result, the club tunicates were consumed in a plethora of different experiments, trying various process iterations, which were crucial to the development of the working 100 kg batch process described herein. However, this exhausted the available 100 kg supply of club tunicates in the lab. Therefore, the process has, so far, only been successfully used to isolate T-CNC from 100 kg of vase tunicate input. However, future work to complete this same process with 100 kg of club tunicate input is feasible. Future work could be developed to optimize and compare the process for both species and to potentially scale up the process further.

### Conclusions

The major conclusions of this work are listed below:

Local invasive club and vase tunicates both contain high quality T-CNC, a renewable and unique high aspect ratio nanomaterial, indicating that they are a valuable untapped resource with potential to be utilized for the benefit of PEI.

A batch wise process utilizing up to 100 kg of raw tunicate input to produce T-CNC has been demonstrated, indicating commercial scale isolation of value-added products such as T-CNC from local invasive tunicates is feasible.

The yield of T-CNCs from our processes was between 10% and 15% based on the dry weight of the tunic powder and T-CNCs isolated therefrom.

The T-CNC product isolated from local vase and club tunicates were demonstrated to have a superior aspect ratio to commercially available W-CNC. The T-CNC also displays superior thermal properties and a higher overall crystallinity than W-CNC.

As a result of its high aspect ratio, the T-CNC percolates a polymer matrix, changing its properties, at lower loading than commercially available low aspect ratio W-CNCs.

Hybrid mixtures of T-CNC and W-CNC have shown synergistic properties, and some of these properties seem to extend to CNC reinforced polymer nanocomposites.

This hybrid effect has been demonstrated in cast film samples utilizing hydrophilic PVA and hydrophobic PLA as polymer matrices.

The hybrid effect was not observed in PLA composites prepared by melt mixing. Although, due to severe aggregation of the hydrophobically modified CNCs, it is feasible that the hybrid effect could be observed in melt mixed composites if aggregation of the CNC can be reduced.

### Applications for Tunicate CNC in the Global CNC Market.

The nanocellulose market is continuing to expand as society moves away from non-renewable products toward sustainable and renewable resources. The market for CNCs is currently dominated by W-CNCs derived from the pulp and paper industry. While these processes are efficient and afford a low cost W-CNC product, their low aspect ratio limits the potential applications for this CNC source. Tunicates by contrast yield CNCs with a much higher aspect ratio, however they are currently only made in small quantities and the economics of the processing is not fully understood. Interestingly, the concept of hybrid CNC mixtures provides a new opportunity in this area. By mixing T-CNCs with W-CNCs, these hybrid CNC mixtures can be made to have not only tailorable average aspect ratios, but also tailorable aspect ratio distributions. This allows for a family of hybrid CNC products to be prepared with tunable properties which are currently not achievable with W-CNC alone. Moreover, given the diverse nature of CNC applications, this family of tunable hybrid CNC products has potential to open up new areas which are currently unavailable to W-CNC due to limitations arising from its low aspect ratio. In general terms: mixing T-CNC and W-CNC results in a hybrid CNC product that has the potential to improve the properties of, and expand the applications for, W-CNC products. This research provides groundwork for development in this area, however future work is necessary to carry it forward.

### Utilizing CNC Production to Address Local Invasive Tunicates on PEI.

By practically demonstrating the feasibility of large-scale tunicate CNC isolation on PEI, we highlight a direct solution to the problems invasive tunicates are causing local aquaculture. By developing other value-added products from the process such as tunicate soap or substituting laboratory grade acetic acid and sodium hypochlorite for vinegar and household bleach, we improve the feasibility of this process being developed commercially on PEI. Which has the potential to directly address the problems invasive tunicates pose while fostering the development of a new local bioeconomy centered on the collection of tunicates, their processing to value added products such as CNC, and the utilization of these local sustainable and renewable products in diverse applications.

### Supplemental Materials:

### S1-Processing

### W-CNC Isolation

Wood-derived CNCs (W-CNCs) were prepared in the Nanocellulose Pilot Plant at the Forest Product Laboratory by sulfuric acid hydrolysis as previously reported (1). Briefly, sulfuric acid (64 wt %) at 45° C. was sprayed onto strips of prehydrolysis kraft rayon-grade dissolving wood pulp under nitrogen. The mixture was stirred at 45° C. for 90 minutes, after which the reaction was quenched with water. The suspension was then bleached with a hypochlorite solution followed by neutralization with NaOH. The W-CNC suspension was allowed to settle and the salt/sugar solution was decanted. The W-CNC suspension was then diluted such that the sodium sulfate concentration dropped to about 1 wt %, at which point the W-CNC particles began to disperse. The aqueous suspension was then transferred to a PCI Membranes A19 tubular ultrafiltration system equipped with FP200 tubular membranes (PVDF 200,000 MWCO) where, during circulation, the dilute salt/sugar solution passed through the membrane while W-CNCs were retained. Reverse osmosis (RO) water was added to maintain the W-CNC concentrate at 1 wt %. Diafiltration was continued until the residual salt concentration of the permeate was reduced to about 8 μM, measured as a conductivity of 40-50 μS/cm². The dispersion was then concentrated to about 10 wt % solids using the tubular ultrafiltration system by circulating without replenishing the water. The overall yield was about 50%.

### Tunicate Collection

Club tunicates (Styela clava) were collected from Malpeque Bay, Prince Edward Island, as described previously (2). Briefly, tunicates were collected and frozen for storage. The tunicates were then thawed and washed with deionized water to remove salt and other debris. The tunic was removed manually from the internal organs using a scalpel, and washed further with deionized water. The tunic was then dried and ground to a fine chalk-like powder using a T-Series 28,000 rpm Multi-function Grinder (HC-150 China) resulting in one kilogram of dried tunic powder (Table S1).

TABLE S4
T-CNC Isolation Process Yield

| | Process | Step 1: | Step 2: | Step 3: |
|---|---|---|---|---|
| | Input | Deproteination | Bleaching | Hydrolysis |
| Mass (g) | ~1 Kg | 386 | 284 | 118 |
| Yield (%) | | 39 | 80 | 42 |

### T-CNC Isolation

Isolation of T-CNCs from the tunic powder generally followed the process described by van den Berg et al. (3), with modification. The dried tunic powder was combined with 6 liters of 5 wt. % NaOH and mixed at 80° C. for 24 hours. The product was then filtered and washed with deionized water until the filtrate was below a pH of 10. This deproteinated tunic product was dried to determine solid content and then combined with deionized water and mixed at 60° C. The pH of the reaction was adjusted to 5.5 using glacial acetic acid. With strong stirring, 50 grams of 80% purity NaClO₂ and 50 mL of glacial acetic acid were added to the reaction mixture. The reaction was covered and allowed to react for 1 hour at 60° C. with periodic stirring. Then a second addition of 50 grams NaClO₂ and 50 mL of glacial acetic acid was added and stirred periodically for 1 hour. Three more additions of NaClO₂ and glacial acetic acid were made in the same fashion. The product was then allowed to cool and settle overnight, followed by filtering, washing with deionized water and drying to determine solid content. Finally, the 280 g of bleached tunic powder was hydrolyzed to T-CNCs by adding five liters of 64 wt % H₂SO₄ with strong stirring for 2 hours at 45° C. The hydrolysis was then stopped by diluting with cool deionized water to a volume of 100 L. Because of residual color, an additional 10 grams of NaClO₂ was added and the dilute T-CNC suspension was allowed to bleach for an additional hour, after which 10% NaOH was used to neutralize the acidic solution to a final volume of 200 L. This highly saline, dilute T-CNC suspension was allowed to settle overnight. Roughly 170 L of supernatant was then removed and the remaining 30 L containing the T-CNC was circulated through a tubular ultrafiltration system (PCI Membranes series flow 1.2 meter B1-modules) equipped with FP200 tubular membranes (PVDF 200,000 MWCO), a circulating pump (Grundfos CR-2), heat exchanger and holding tank. This was a similar setup as for the W-CNC preparation, only smaller.

Residual sodium sulfate was removed by diafiltration over 48 hours, after which the permeate conductivity was measured below 50 μS/cm. During the initial filtration process, aggregated tunicate derivatives obstructed the circulation pump, reducing the operating efficiency of the equipment. We corrected this by cleaning the pump and centrifuging the suspension using a Sharples model AS16 centrifuge (17500 G, two minute retention time) to remove smaller aggregates (See S4). The aggregated tunicate derivatives were separated, dried, and were found to weigh <2 grams. However, this small amount of aggregates lead to additional processing and cleaning steps which lead to a further reduction of yield. We speculate that these aggregates are in fact the same areas of the tunic removed during the tunic powder preparation step performed by van den Berg et al. (3), which was described as a particularly difficult area of the tunic to deproteinate near the animals' siphons. In the lab scale, van den Berg et al. (3) removed these areas, however emulating commercial scale processing we used the entire tunic. After centrifugation, remaining aggregated tunicate derivatives were removed via filtration using an 80 mesh screen, leading to additional product loss. The diafiltration process was then completed and the T-CNC suspension was concentrated. A total of 118 g of T-CNCs were produced in this process as an aqueous suspension approximately 20 L in volume and 0.58 wt % concentration, representing a 42% yield for the H₂SO₄ hydrolysis.

### CNC Dispersability

Both W-CNCs and T-CNCs are prepared as aqueous suspensions. To determine if these solutions could be dried and later redispersed; we lyophilized samples of both and attempted to redisperse them with the aid of sonication. As seen in FIG. 16, both W-CNCs and T-CNCs were found to be redispersible in water as evidenced by shear birefringence.

### S2—Elemental Analysis: ICP-OES and EDS

TABLE S2
Elemental analysis of T-CNCs and W-CNCs via ICP-OES.

| | Sulfur | Sodium | Calcium | |
|---|---|---|---|---|
| T-CNCs | 0.61 wt % | 0.35 wt % | 0.054 | wt % |
| WCNCs | 1.06 wt % | 0.87 wt % | <0.002 | wt % * |

* Based on typical values observed in past W-CNC isolation.

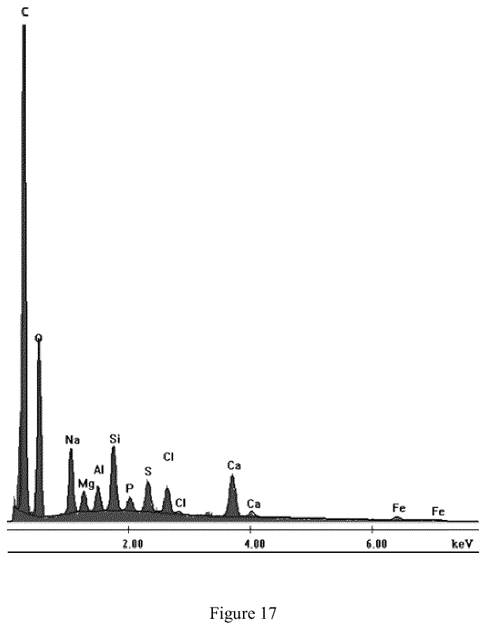

Measured EDS data for dried tunic powder is shown in FIG. 17.

### S4—Dynamic Light Scattering (DLS)

### Laser Light Scattering

TABLE S4a
Dynamic Laser Light Scattering information obtained for aggregate
laden T-CNC solution and small-scale initial T-CNC isolation
following the van den Berg et al. procedure (3).

| | Mean Effective | |
|---|---|---|
| | Diameter (MED) | Polydispersity |
| Small Scale | 395.6 nm (s.d. 6.81) | 0.273 (s.d. 0.022) |
| Crude T-CNC | 908.4 nm (s.d. 68.6) | 0.376 (s.d. 0.016) |
| T-CNC Centrifuge 1X | 675.9 nm (s.d. 68.3) | 0.362 (s.d. 0.010) |
| T-CNC Centrifuge + 8X | 445.1 nm (s.d. 22.1) | 0.329 (s.d. 0.019) |

A Sharples model AS16 centrifuge (17500 G, two minute retention time) was used twice to remove small aggregates in combination with manual screening (80 mesh) for large aggregates. First, the T-CNC suspension was centrifuged 1× (2 minutes retention time) and screened for aggregates. Then the suspension was centrifuged again, and after 8× (16 minutes retention time) through the centrifuge, the MED and polydispersity were determined to be comparable to a small scale batch of T-CNCs (Table S4a) prepared by the procedure of van den Berg et al. (3). The T-CNC suspension was then screened a final time and the diafiltration and concentration processes were completed. These findings are in close agreement with similar reports of DLS measurements on T-CNCs isolated at lab scale (5). Although not shown, AFM was used to determine individualization of the T-CNCs produced by the small scale batch, ensuring it was a suitable qualitative standard for our larger scale processing.

TABLE S4b
Zeta potential of the final W-CNC and T-CNC products.

| Sample | W-CNC | T-CNC |
|---|---|---|
| Zeta potential (mV) | −52.90 | −41.09 |

Zeta potential was performed using a Brookhaven NanoBrook 90PlusPALS system. The W-CNC and T-CNC samples were sonicated for 20 minutes, diluted with deionized water and were analyzed at 25° C. The total number of cycles for each sample was 30 with Inter-cycle delay of 1 second.

### S5—CNC Morphology

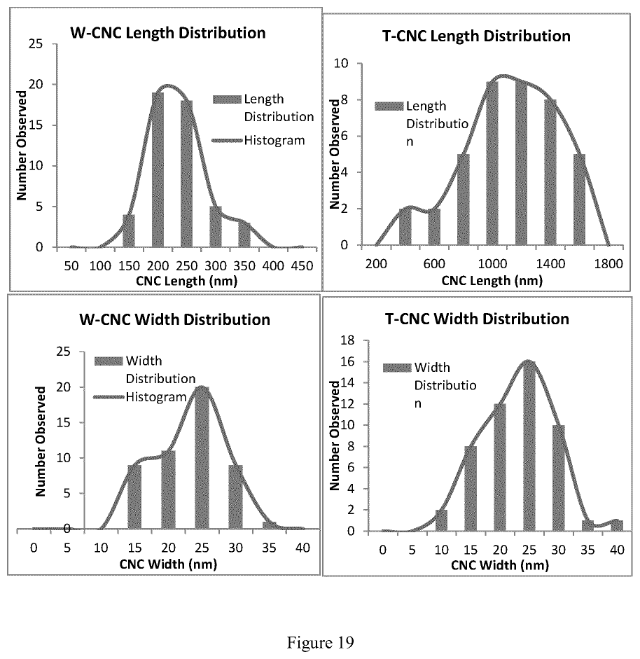

We note that both the W-CNCs and T-CNCs display relatively high average width (6, 7), which we attribute to incomplete hydrolysis, to the parallel clustering of CNCs during TEM analysis, to a combination of both, or to human error when obtaining and statistically analyzing the TEM images. Irrespective, a reduced CNC width results in an increasing CNC aspect ratio, indicating that our TEM analysis may, if anything, underestimate the aspect ratio of both CNC sources. The length and width distributions of W-CNC and T-CNCs are shown in FIG. 19.

TABLE S5
Morphology of T-CNCs and W-CNCs determined from TEM

| | W-CNCs | T-CNCs |
|---|---|---|
| Length | 215 ± 56 | 1214 ± 505 |
| Width | 20 ± 5 | 20 ± 6 |
| Aspect Ratio | 12 ± 4 | 65 ± 25 |

### S6—FTIR

TABLE S6
Noted FTIR signals for W-CNC and T-CNC.

| Wavenumber (cm⁻¹) | Functional Group | Reference |
|---|---|---|
| 3340 | —OH | (8) |
| 2900 | C—H | (9) |
| 1640 | H—O—H | (10, 11) |
| 1160 | C—O—C | (9, 12) |
| 1050 | C—O—C | (9, 12) |
| 897 | C₁ (anomeric) | (13) |

The FTIR spectra of W-CNC and T-CNC are visible in Figure S6, and tabulated in Table S6. They display similar characteristic peaks associated with CNCs and cellulose more broadly. The broad absorption in the area around 3300 cm⁻¹ is indicative of OH stretching, arising from both intermolecular and intramolecular hydrogen bonding. Other expected signals are observed at 2900, 1160 and 1050 which result from C—H symmetric stretching, C—O—C glucose skeletal stretching and C—O—C pyranose stretching, respectively (9, 12). A small signal visible at 1640 cm⁻¹ has been shown to represent free H₂O (10, 14). Although the CNC samples were lyophilized to remove H₂O, we assess that the highly hydrophilic nature of these materials led to H₂O absorption from the environment during and immediately prior to analysis. Additionally, a peak associated with the anomeric (C1) vibration of the β(1-4) glycosidic linkages present in cellulose was observed at 897 cm⁻¹ (13).

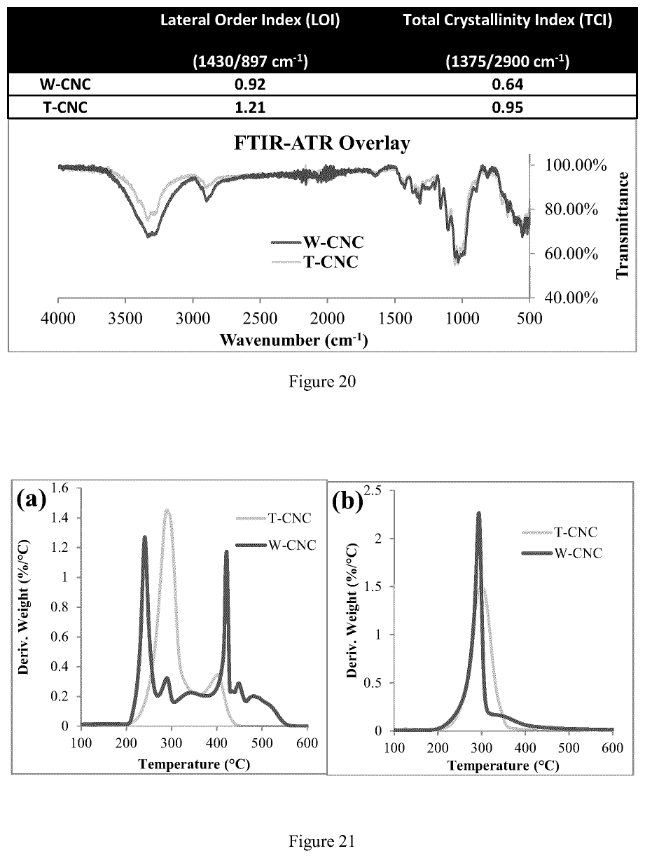

The Lateral Order Index (LOI) and Total Crystallinity Index (TCI) of the isolated T-CNCs and W-CNCs was assessed by comparing the spectral ratio of the 1430/897 cm⁻¹ (15, 16) and the 1375/2900 cm⁻¹ (17) bands respectively (FIG. 20). The ratio of the intensity of absorption in these bands has been shown to indicate increased crystallinity and cellulose I structure. Therefore, we calculated the absorbance at the four bands necessary to determine the LOI and TCI of the prepared CNCs (18). These values, indicate that the T-CNCs exhibit a higher crystallinity than W-CNCs when calculated by both the LOI and TCI methods. These findings are further supported by the results of Kumar et al. who reported a LOI and TCI of 0.57 and 1.32 respectively for W-CNCs isolated from Sugarcane Bagasse, a common agricultural waste product (11).

### S7 XRD

Both CNC sources displayed intense signals characteristic of the 200 crystalline cellulose reflection and weaker signals associated the 004 cellulose reflection at 22.5° and 34.5° 20 (11). The T-CNCs produced in this work display signals at 15° and 17° (2θ), consistent with the 11̅0 and 110 reflections expected in a highly crystalline cellulose Iβ structure (19). As expected, the W-CNC displayed a broad peak centered at 16.5° (2θ), indicative of the lower crystallinity and smaller crystallite size of the W-CNCs (6).

TABLE S7
Summary of structural properties
obtained from XRD diffractograms.

| Crystallographic Plane | 11̅0 | 110 | 200 | 004 |
|---|---|---|---|---|
| Degree (2θ) | 15 | 17 | 22.5 | 34.5 |

| | T-CNC | W-CNC |
|---|---|---|
| Crystallinity (%) | 75 | 66 |

### S8—TGA

Feng and Hsieh observed that a decrease in the thermal stability of CNCs is related to an increase in surface area as particle size decreases (20). Since the W-CNCs are smaller particles with a higher surface area than T-CNCs, this finding is consistent with our experimental results. The appearance of separate shoulders in the TGA thermograms of W-CNCs in air may be due to the presence of surface sulfate groups (11, 21). The elimination of H₂SO₄ from the sulfated CNCs requires little thermal energy, leading to a lower thermal stability of CNCs that are sulfated compared to unmodified CNCs (22). In this work however, both the T-CNCs and W-CNCs studied were modified with surface sulfate groups, yet only the W-CNCs exhibit multiple separate shoulders in TGA thermograms performed in air. Using ICP-OES (S2) we determined that the sulfur content of the W-CNCs is almost double that of the T-CNCs (1.06% and 0.61% respectively). While these are in the typical range for CNCs isolated via sulfuric acid hydrolysis from wood (23) and tunicate cellulosic feedstocks, the considerable differences in sulfur content complicate comparisons between W-CNC and T-CNC thermograms.

The TGA thermograms displayed changes in the rate of mass loss which are clearly visible in the derivative TGA (DTGA) thermograms. By observing the DTGA thermograms, the inflection points of the T-CNCs are clearly visible preceding that of the W-CNCs in air (FIG. 21, a) and in nitrogen (FIG. 21, b). Consistent with past reports, there appear to be two main inflection points in air for W-CNCs (24, 25), whereas T-CNC in air and both CNCs under nitrogen display only one main inflection point (2). Additionally, the inflection point observed for T-CNCs remains relatively constant in air and nitrogen. However W-CNCs show an earlier inflection point in air than in inert nitrogen, suggesting that W-CNCs poses an increased susceptibility to thermal oxidation than T-CNCs.

TABLE S8
Summary of thermal properties obtained
from TGA and DTGA thermograms.

| | TGA-Air | | TGA-Nitrogen | |
|---|---|---|---|---|
| | T-CNC | W-CNC | T-CNC | W-CNC |
| Onset Temperature (° C.) | 225 | 210 | 239 | 237 |
| Ash (%) | 3 | 4 | 8 | 19 |

| | DTGA-Air | | DTGA-Nitrogen | |
|---|---|---|---|---|
| | T-CNC | W-CNC | T-CNC | W-CNC |
| Inflection Point (° C.) | 291 | 240 & 421 | 300 | 295 |

### NCC Based Coating for Improving the Properties of Paper Packaging

Paper based packaging could potentially replace plastic by being natural and biodegradable. However, the requirement for higher mechanical properties and physical properties, and cost of production could be a challenge. PEI Bag Co. produces paper bags for potato packaging. A master bag is a two-ply SOS style bag typically measuring 14 in×7 in by 32 or 34 in long. The commodity items sold to local and the US customers accounting for a strong percentage of PEI bag Co sales. While the level of customer bag breakage is minimal, there are always issues with breakages. The PEI Bag corporation is interested to understands ways that can reduce the breakages of the bags.

In this project a biodegradable coating comprising of tunicate-based cellulose nanocrystals and polyvinyl alcohol is investigated to improve the mechanical and physico-chemical properties of the paper bags. The section below discusses the methods and the results for various compositions of the coating materials.

### Materials & Methodology

To prepare the biodegradable glue, 5 g of the polyvinyl alcohol (PVA) pellets (MW=124 kDa) was mixed with 95 g of distilled water in a beaker. The mixture was placed on a heated plate at 90° C. with strong stirring for three hours to allow full dissolution of the PVA. Then the 5 wt % PVA solution was mixed with different proportions of 1 wt % tunicate derived CNC. The final glue compositions are represented in the table below. In samples 1-4, the total solid content of the aqueous glue solution is roughly 0.23 wt %, and in samples 5-8 the total solid content is roughly 0.46 wt %. Sample 9 is a control sample without any adhesives added. The total CNC content of the adhesive is also varied between 0 and 5 wt %, to determine the ideal CNC:PVA ratio necessary to optimize the desired mechanical performance characteristics of the paper samples.

| | | | PVA | | CNC | Total solid | Total solvent |
|---|---|---|---|---|---|---|---|
| Sample | Glue | PVA | (weight %) | CNC | (weight %) | content of | content of |
| number | applied (g) | (grams) | dry | (grams) | dry | glue (wt %) | glue (wt %) |
| 1 | 10 | 0.25 | 100 | 0 | 0 | 0.25 | 99.75 |
| 2 | 10 | 0.2375 | 98.958 | 0.0025 | 1.041 | 0.24 | 99.76 |
| 3 | 10 | 0.225 | 97.826 | 0.005 | 2.173 | 0.23 | 99.77 |
| 4 | 10 | 0.2 | 95.238 | 0.01 | 4.761 | 0.21 | 99.79 |
| 5 | 10 | 0.5 | 100 | 0 | 0 | 0.5 | 99.5 |
| 6 | 10 | 0.475 | 98.958 | 0.005 | 1.041 | 0.48 | 99.52 |
| 7 | 10 | 0.45 | 97.826 | 0.01 | 2.173 | 0.46 | 99.54 |
| 8 | 10 | 0.4 | 95.232 | 0.02 | 4.761 | 0.42 | 99.58 |
| 9 | 0 | 0 | 0 | 0 | 0 | 0 | 0 |

After preparing the glue samples, 10 g of each prepared glue was applied equally between two layers of A4 size paper sheets cut from paper bags provided by PEI Bag Company. The samples were dried for 24 h under compression. After drying, the samples were sent to an independent laboratory operated by Georgia-Pacific for analysis.

### Results & Discussion

### Mechanical Properties

The tensile strength (TS) is described as the maximum tensile stress that a polymer can tolerate. Elongation at break (EB) is described as the maximum change in length of the test sample at the breaking point. Tensile strength (TS), and elongation at break (EB) were evaluated by various ASTM standard methods at the Georgia Pacific Lab. Three replicates samples were analyzed for each film specimen. TS, and EB were calculated by Eq. (1) and Eq. (2) respectively. Data was acquired for both samples oriented parallel to the machine direction (MD) and for samples oriented perpendicular to (or ‘cross’) the machine direction (CD).

Where FMax is maximum load, AMin is minimum cross-section area, LMax is extension at the moment of rupture, L0 is the initial length of the specimen.

$$TS = \frac{{F}_{Max}}{{A}_{Min}} \qquad [ 1 ]$$

$$EB = \frac{{L}_{Max}}{{L}_{0}} \qquad [ 2 ]$$

The mechanical properties of the samples were assessed and the resulting data is presented in Table 2. As expected the values for MD were higher than the CD values. In terms of the tensile strength, comparison between the treated samples and the control sample showed a significant difference. In addition to this, the tear strength of the treated samples was higher than the control sample which confirms the increase in mechanical properties of the paper product. Generally speaking it is clear that introducing an additional PVA:CNC adhesive between the paper layers has led to significant mechanical improvements. The PVA on its own provides significant support, however this is primarily a viscous reinforcement prone to deform under strain, leading to the enhanced % Elongation observed in the MD samples. To balance the viscous nature of the PVA, CNC is added to increase the elastic component of the adhesive. This translates to the enhanced Tensile, Tear, and Wet Tensile reinforcement observed in samples with elastic CNCs reinforcing the viscous PVA. Overall, the mechanical properties of all samples were improved by the addition of PVA:CNC adhesive and the CNCs are clearly providing a tunable elastic reinforcement to the adhesive.

To prepare Sample 3, a total of 0.2375 g of PVA, 0.0025 g of CNC and 9.76 g of deionized water was used to laminate two standard A4 sheets of paper (Surface Area ˜0.0625 m²), resulting in significant mechanical performance improvements. Extrapolating this out allows us to estimate that 3.8 g of PVA, 0.04 g of CNC and 156.16 g of water while be necessary to laminate 1 square meter of paper in the same manner. Based on paper bags measuring 14″/7″/34″ (Surface area ˜1526 in2 or 0.9845 m2), the material used to fully laminate a single double ply paper bag would be 3.74 g of PVA, 0.039 g CNC and 153.7 g water. Assuming negligible water cost and a market price of PVA (˜$3/kg in bulk [Alibaba]) and CNC (˜10$/kg in bulk [CelluForce]); this translates to an estimated additional cost of ˜1.162 cents to laminate each bag with a fully biodegradable adhesive of the described composition. If this represents 60% of the overall cost, then total cost including equipment and other cost for implementing it could be 2 cents. It is anticipated that the adhesives prepared for this study can be further optimized and that the estimated additional cost per bag could either be slightly lowered while preserving mechanical properties, or, for a moderate increase in cost per bag, additional additives could be utilized in an effort to further enhance mechanical performance.

| | Tensile, | Tensile, | Elongation, | Elongation, | Wet Tensile, | Wet Tensile, | Tear | Tear |
|---|---|---|---|---|---|---|---|---|
| Sample | CD | MD | CD | MD | CD | MD | CD | MD |
| number | (MPa) | (MPa) | (%) | (%) | (Mpa) | (Mpa) | (N) | (N) |
| 1 | 261 | 468 | 7.4 | 2.1 | 71 | 135 | 1.24 | 1.34 |
| 2 | 289 | 483 | 8.0 | 1.8 | 75 | 148 | 1.36 | 1.42 |
| 3 | 283 | 479 | 7.2 | 1.8 | 73 | 138 | 1.50 | 1.40 |
| 4 | 296 | 483 | 8.5 | 1.5 | 71 | 136 | 1.63 | 1.25 |
| 5 | 295 | 331 | 7.7 | 1.9 | 69 | 147 | 1.37 | 1.67 |
| 6 | 288 | 493 | 8.5 | 1.3 | 73 | 146 | 1.55 | 1.39 |
| 7 | 246 | 485 | 6.9 | 2.4 | 67 | 137 | 1.59 | 1.26 |
| 8 | 240 | 387 | 7.3 | 1.9 | 71 | 75 | 1.61 | 1.25 |
| 9 (control) | 131 | 213 | 7.9 | 1.3 | 34 | 55 | 1.03 | 1.14 |

### Conclusions

The results of the study showed that the application of fully biodegradable CNC-based glue enhanced the mechanical properties of the paper samples. By tuning the ratio of PVA:CNC we can control the mechanical performance characteristics of a laminated paper product. Adhesive samples were demonstrated to improve the Tensile, Wet Tensile and Tear resistance of all samples in both the MD and CD directions compared to samples without adhesive. Samples containing PVA reinforced with CNC (Sample 3 for example) displayed further improvements in the Tensile, Wet Tensile and Tear resistance compared to the neat PVA reinforcement. Using Sample 3 as an example, we estimated an additional adhesive cost of roughly 1.2 cents per bag based on the current market prices for the bulk materials. We assess that this adhesive, or one of similar composition, has the capacity to be applied on the paper bag production line for a practical scaled-up study.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

### REFERENCES

1. Ummartyotin, S.; Manuspiya, H. A critical review on cellulose: From fundamental to an approach on sensor technology. Renewable and Sustainable Energy Reviews 2015, 41, 402-412.
2. Dunlop, M. J.; Acharya, B.; Bissessur, R. Effect of Cellulose Nanocrystals on the Mechanical Properties of Polymeric Composites. In Biocomposite Materials: Design and Mechanical Properties Characterization; Hameed Sultan, M. T., Majid, M. S. A., Jamir, M. R. M., Azmi, A. I. and Saba, N., Eds.; Springer Singapore: Singapore, 2021; pp 77-95.
3. Beck-Candanedo, S.; Roman, M.; Gray, D. G. Effect of reaction conditions on the properties and behavior of wood cellulose nanocrystal suspensions. Biomacromolecules 2005, 6, 1048-1054.
4. Roman, M.; Winter, W. T. Effect of sulfate groups from sulfuric acid hydrolysis on the thermal degradation behavior of bacterial cellulose. Biomacromolecules 2004, 5, 1671.
5. El Achaby, M.; Kassab, Z.; Aboulkas, A.; Gaillard, C.; Barakat, A. Reuse of red algae waste for the production of cellulose nanocrystals and its application in polymer nanocomposites. Int. J. Biol. Macromol. 2018, 106, 681-691.
6. Van Daele, Y.; Revol, J.; Gaill, F.; Goffinet, G. Characterization and supramolecular architecture of the cellulose-protein fibrils in the tunic of the sea peach (Halocynthia papillosa, Ascidiacea, Urochordata). Biology of the Cell 1992, 76, 87-96.
7. Sacui, I. A.; Nieuwendaal, R. C.; Burnett, D. J.; Stranick, S. J.; Jorfi, M.; Weder, C.; Foster, E. J.; Olsson, R. T.; Gilman, J. W. Comparison of the Properties of Cellulose Nanocrystals and Cellulose Nanofibrils Isolated from Bacteria, Tunicate, and Wood Processed Using Acid, Enzymatic, Mechanical, and Oxidative Methods. ACS Appl. Mater. Interfaces 2014, 6, 6127-6138.
8. de Menezes, A. J.; Siqueira, G.; Curvelo, A. A.; Dufresne, A. Extrusion and characterization of functionalized cellulose whiskers reinforced polyethylene nanocomposites. Polymer 2009, 50, 4552.
9. Zhao, Y.; Li, J. Excellent chemical and material cellulose from tunicates: diversity in cellulose production yield and chemical and morphological structures from different tunicate species. Cellulose 2014, 21, 3427-3441.
10. French, A. D.; Michael, S. C. Cellulose polymorphy, crystallite size, and the Segal crystallinity index. Cellulose 2013, 20.
11. Boluk, Y.; Moon, R.; Ensor, D.; Nieh, W.; Forsstrom, U.; Shatkin, J. A.; Gardner, D. J.; Teague, C.; Haydon, B.; Walker, C. Roadmap for the Development of International Standards for Nanocellulose. Arlington, US 2011.
12. Elazzouzi-Hafraoui, S.; Nishiyama, Y.; Putaux, J.; Heux, L.; Dubreuil, F.; Rochas, C. The Shape and Size Distribution of Crystalline Nanoparticles Prepared by Acid Hydrolysis of Native Cellulose. Biomacromolecules 2008, 9, 57-65.
13. Park, S. Cellulose crystallinity index: measurement techniques and their impact on interpreting cellulase performance. Biotechnol Biofuels 2010, 3.
14. Zhao, Y. Cellulose nanofibers from softwood, hardwood, and tunicate: preparation-structure-film performance interrelation. ACS Appl Mater Interfaces 2017, 9.
15. Li, K.; Mcgrady, D.; Zhao, X.; Ker, D.; Tekinalp, H.; He, X.; Qu, J.; Aytug, T.; Cakmak, E.; Phipps, J. Surface-modified and oven-dried microfibrillated cellulose reinforced biocomposites: Cellulose network enabled high performance. Carbohydr. Polym. 2020, 256, 117525.
16. Sugiyama, J.; Persson, J.; Chanzy, H. Combined infrared and electron diffraction study of the polymorphism of native celluloses. Macromolecules 1991, 24, 2461-2466.
17. Jiang, F.; Hsieh, Y. Chemically and mechanically isolated nanocellulose and their self-assembled structures. Carbohydrate Polymers 2013, 95, 32-40.
18. Jonoobi, M.; Oladi, R.; Davoudpour, Y.; Oksman, K.; Dufresne, A.; Hamzeh, Y.; Davoodi, R. Different preparation methods and properties of nanostructured cellulose from various natural resources and residues: a review. Cellulose 2015, 22, 935-969.
19. Hon, D. N. -. Cellulose: a random walk along its historical path. Cellulose 1994, 1, 1.
20. Kim, J. -. H. Review of nanocellulose for sustainable future materials. Int J Precis Eng Manuf-Green Technol 2015, 2.
21. TAPPI; Ireland Sean TAPPI WEBINAR OVERVIEW PROPERTIES AND OPPORTUNITIES FOR NANOCELLULOSE. 2019.
22. Canada, N. R. C. Certified reference materials. 2019.
23. Habibi, Y.; Lucia, L. A.; Rojas, O. J. Cellulose Nanocrystals: Chemistry, Self-Assembly, and Applications. Chem. Rev. 2010, 110, 3479-3500.
24. Saddler, J. N.; Brownell, H. H.; Clermont, L. P.; Levitin, N. Enzymatic hydrolysis of cellulose and various pretreated wood fractions. Biotechnology and Bioengineering 1982, 24, 1389-1402.
25. Roy, D.; Semsarilar, M.; Guthrie, J. T.; Perrier, S. Cellulose modification by polymer grafting: a review. Chem. Soc. Rev. 2009, 38, 2046.
26. Meesorn, W.; Shirole, A.; Vanhecke, D.; de Espinosa, L. M.; Weder, C. A Simple and Versatile Strategy To Improve the Mechanical Properties of Polymer Nanocomposites with Cellulose Nanocrystals. Macromolecules 2017, 50, 2364.
27. Shanmuganathan, K.; Capadona, J. R.; Rowan, S. J.; Weder, C. Biomimetic mechanically adaptive nanocomposites. Progress in Polymer Science 2010, 35, 212-222.
28. Araki, J.; Wada, M.; Kuga, S.; Okano, T. Flow properties of microcrystalline cellulose suspension prepared by acid treatment of native cellulose. Colloids Surf., A 1998, 142, 75.
29. De Menezes, A. J.; Siqueira, G.; Curvelo, A. A.; Dufresne, A. Extrusion and characterization of functionalized cellulose whiskers reinforced polyethylene nanocomposites. Polymer 2009, 50, 4552-4563.
30. de Rodriguez, Nancy Lis Garcia; Thielemans, W.; Dufresne, A. Sisal cellulose whiskers reinforced polyvinyl acetate nanocomposites. Cellulose 2006, 13, 261-270.
31. Kimura, F.; Kimura, T.; Tamura, M.; Hirai, A.; Ikuno, M.; Horii, F. Magnetic alignment of the chiral nematic phase of a cellulose microfibril suspension. Langmuir 2005, 21, 2034-2037.
32. George, J.; Bawa, A. S. In In Synthesis and characterization of bacterial cellulose nanocrystals and their PVA nanocomposites; Advanced Materials Research; Trans Tech Publ: 2010; Vol. 123, pp 383-386.
33. George, J. High performance edible nanocomposite films containing bacterial cellulose nanocrystals. Carbohydr. Polym. 2012, 87, 2031-2037.
34. Azizi Samir, M. A. S.; Alloin, F.; Dufresne, A. Review of recent research into cellulosic whiskers, their properties and their application in nanocomposite field. Biomacromolecules 2005, 6, 612.
35. Miller, J. In In Nanocellulose: technology applications, and markets; TAPPI international conference on nanotechnology for renewable materials; 2014; pp 23-26.
36. Sharma, A.; Thakur, M.; Bhattacharya, M.; Mandal, T.; Goswami, S. Commercial application of cellulose nano-composites-A review. Biotechnology Reports 2019, e00316.
37. Chauve, G.; Bras, J. Industrial point of view of nanocellulose materials and their possible applications. In HANDBOOK OF GREEN MATERIALS: 1 Bionanomaterials: separation processes, characterization and properties World Scientific: 2014; pp 233-252.
38. Reiner, R. S.; Rudie, A. W. 1 Process Scale-Up of Cellulose Nanocrystal Production to 25 kg per Batch at the Forest Products Laboratory. In: Production and applications of Cellulose nanomaterials, TAPPI Press, Chapter 1.1, 2013; pp. 21-24. 2013, 1, 21-24.
39. Durán, N.; Lemes, A. P.; Durán, M.; Freer, J.; Baeza, J. A minireview of cellulose nanocrystals and its potential integration as co-product in bioethanol production. Journal of the Chilean Chemical Society 2011, 56, 672-677.
40. Chen, G.; Wu, G.; Alriksson, B.; Chen, L.; Wang, W.; Jonsson, L. J.; Hong, F. F. Scale-up of production of bacterial nanocellulose using submerged cultivation. Journal of Chemical Technology & Biotechnology 2018, 93, 3418-3427.
41. Masaoka, S.; Ohe, T.; Sakota, N. Production of cellulose from glucose by Acetobacter xylinum. J. Ferment. Bioeng. 1993, 75, 18-22.
42. Dunlop, M. J. Isolation of nanocrystalline cellulose from tunicates. J Environ 2018, 6.
43. Moon, R. J.; Martini, A.; Nairn, J.; Simonsen, J.; Youngblood, J. Cellulose nanomaterials review: structure, properties and nanocomposites. Chem. Soc. Rev. 2011, 40, 3941.
44. Habibi, Y.; Goffin, A . . . ; Schiltz, N.; Duquesne, E.; Dubois, P.; Dufresne, A. Bionanocomposites based on poly (ε-caprolactone)-grafted cellulose nanocrystals by ring-opening polymerization. J. Mater. Chem. 2008, 18, 5002.
45. Wang, B.; Sain, M.; Oksman, K. Study of Structural Morphology of Hemp Fiber from the Micro to the Nanoscale. Applied Composite Materials 2007, 14, 89.
46. Souza Lima, M. M. Rodlike cellulose microcrystals: structure, properties, and applications. Macromol Rapid Comm 2004, 25.
47. Saito, T.; Kimura, S.; Nishiyama, Y.; Isogai, A. Cellulose nanofibers prepared by TEMPO-mediated oxidation of native cellulose. Biomacromolecules 2007, 8, 2485.
48. Dehal, P.; Satou, Y.; Campbell, R. K.; Chapman, J.; Degnan, B.; De Tomaso, A.; Davidson, B.; Di Gregorio, A.; Gelpke, M.; Goodstein, D. M. The draft genome of Ciona intestinalis: insights into chordate and vertebrate origins. Science 2002, 298, 2157-2167.
49. Dunlop, M. J.; Acharya, B.; Bissessur, R. Isolation of nanocrystalline cellulose from tunicates. Journal of Environmental Chemical Engineering 2018, 6, 4408-4412.
50. Brown, E. E.; Laborie, M. G. Bioengineering bacterial cellulose/poly (ethylene oxide) nanocomposites. Biomacromolecules 2007, 8, 3074-3081.
51. Tokoh, C.; Takabe, K.; Fujita, M.; Saiki, H. Cellulose synthesized by Acetobacter xylinum in the presence of acetyl glucomannan. Cellulose 1998, 5, 249-261.
52. Yamamoto, H.; Horn, F. In Situ crystallization of bacterial cellulose I. Influences of polymeric additives, stirring and temperature on the formation celluloses I α and I β as revealed by cross polarization/magic angle spinning (CP/MAS) 13 C NMR spectroscopy. Cellulose 1994, 1, 57-66.
53. Hanley, S. J.; Revol, J.; Godbout, L.; Gray, D. G. Atomic force microscopy and transmission electron microscopy of cellulose from Micrasterias denticulata; evidence for a chiral helical microfibril twist. Cellulose 1997, 4, 209-220.
54. Revol, J. On the cross-sectional shape of cellulose crystallites in Valonia ventricosa. Carbohydr. Polym. 1982, 2, 123-134.
55. Patterson, G. Cellulose before CELL: Historical themes. Carbohydrate polymers 2021, 252, 117182.
56. Hon, D. N. Cellulose: a random walk along its historical path. Cellulose 1994, 1, 1-25.
57. Moon, R. J.; Martini, A.; Nairn, J.; Simonsen, J.; Youngblood, J. Cellulose nanomaterials review: structure, properties and nanocomposites. Chem. Soc. Rev. 2011, 40, 3941-3994.
58. Lin, N.; Chen, Y.; Hu, F.; Huang, J. Mechanical reinforcement of cellulose nanocrystals on biodegradable microcellular foams with melt-compounding process. Cellulose 2015, 22, 2629.
59. Kargarzadeh, H.; Mariano, M.; Huang, J.; Lin, N.; Ahmad, I.; Dufresne, A.; Thomas, S. Recent developments on nanocellulose reinforced polymer nanocomposites: A review. Polymer 2017, 132, 368-393.
60. Dunlop, M. J.; Acharya, B.; Bissessur, R. Study of plant and tunicate based nanocrystalline cellulose in hybrid polymeric nanocomposites. Cellulose 2020, 27, 249-261.
61. Klemm, D.; Kramer, F.; Moritz, S.; Lindström, T.; Ankerfors, M.; Gray, D.; Dorris, A. Nanocelluloses: a new family of nature-based materials. Angewandte Chemie International Edition 2011, 50, 5438-5466.
62. Dufresne, A. Polysaccharide nano crystal reinforced nanocomposites. Can. J. Chem. 2008, 86, 484.
63. Takayanagi, M.; Uemura, S.; Minami, S. In In Application of equivalent model method to dynamic rheo-optical properties of crystalline polymer; Journal of Polymer Science Part C: Polymer Symposia; Wiley Online Library: 1964; Vol. 5, pp 113-122.
64. Halpin, J. C.; Kardos, J. L. Moduli of crystalline polymers employing composite theory. J. Appl. Phys. 1972, 43, 2235-2241.
65. Peng, B. L. Chemistry and applications of nanocrystalline cellulose and its derivatives: a nanotechnology perspective. Can. J. Chem. Eng. 2011, 89.
66. Wong, K. K. H.; Zinke-Allmang, M.; Hutter, J. L.; Hrapovic, S.; Luong, J. H.; Wan, W. The effect of carbon nanotube aspect ratio and loading on the elastic modulus of electrospun poly (vinyl alcohol)-carbon nanotube hybrid fibers. Carbon 2009, 47, 2571-2578.
67. Jiang, M.; Dang, Z.; Xu, H.; Yao, S.; Bai, J. Effect of aspect ratio of multiwall carbon nanotubes on resistance-pressure sensitivity of rubber nanocomposites. Appl. Phys. Lett. 2007, 91, 072907.
68. Yao, S.; Dang, Z.; Jiang, M.; Xu, H.; Bai, J. Influence of aspect ratio of carbon nanotube on percolation threshold in ferroelectric polymer nanocomposite. Appl. Phys. Lett. 2007, 91, 212901.
69. Kim, N.; Walker, C. In In Advancing Commercialization of Nanocellulose: Critical Challenges Workshop; U.S.D.A. Forest Service and National Nanotechnology Coordinating Office in support of the Sustainable Nanomanufacturing Signature Initiative: Washington, DC, May 7-8, 2019.
70. Oksman, K.; Aitomäki, Y.; Mathew, A. P.; Siqueira, G.; Zhou, Q.; Butylina, S.; Tanpichai, S.; Zhou, X.; Hooshmand, S. Review of the recent developments in cellulose nanocomposite processing. Composites, Part A 2016, 83, 2.
71. Hendren, K. D.; Higgins, M. A.; Long, B. K.; Foster, E. J. Cellulose nanocrystal-reinforced poly (5-triethoxysilyl-2-norbornene) composites. Polymer Chemistry 2020, 11, 433-438.
72. Chen, Q.; Zhou, L.; Zou, J.; Gao, X. The preparation and characterization of nanocomposite film reinforced by modified cellulose nanocrystals. Int. J. Biol. Macromol. 2019, 132, 1155-1162.
73. Meesorn, W.; Zoppe, J. O.; Weder, C. Stiffness-Changing of Polymer Nanocomposites with Cellulose Nanocrystals and Polymeric Dispersant. Macromolecular rapid communications 2019, 40, 1800910.
74. Rusli, R.; Shanmuganathan, K.; Rowan, S. J.; Weder, C.; Eichhorn, S. J. Stress-transfer in anisotropic and environmentally adaptive cellulose whisker nanocomposites. Biomacromolecules 2010, 11, 762.
75. Favier, V.; Canova, G.; Cavaillé, J.; Chanzy, H.; Dufresne, A.; Gauthier, C. Nanocomposite materials from latex and cellulose whiskers. Polym. Adv. Technol. 1995, 6, 351.
76. Dubief, D.; Samain, E.; Dufresne, A. Polysaccharide microcrystals reinforced amorphous poly (β-hydroxyoctanoate) nanocomposite materials. Macromolecules 1999, 32, 5765-5771.
77. Dagnon, K. L.; Shanmuganathan, K.; Weder, C.; Rowan, S. J. Water-triggered modulus changes of cellulose nanofiber nanocomposites with hydrophobic polymer matrices. Macromolecules 2012, 45, 4707-4715.
78. Jorfi, M.; Roberts, M. N.; Foster, E. J.; Weder, C. Physiologically responsive, mechanically adaptive bio-nanocomposites for biomedical applications. ACS applied materials & interfaces 2013, 5, 1517-1526.
79. Sapkota, J.; Shirole, A.; Foster, E. J.; Garcia, J. C. M.; Lattuada, M.; Weder, C. Polymer nanocomposites with nanorods having different length distributions. Polymer 2017, 110, 284-291.
80. Yang, S.; Lin, W.; Huang, Y.; Tien, H.; Wang, J.; Ma, C. M.; Li, S.; Wang, Y. Synergetic effects of graphene platelets and carbon nanotubes on the mechanical and thermal properties of epoxy composites. Carbon 2011, 49, 793-803.
81. El Miri, N.; El Achaby, M.; Fihri, A.; Larzek, M.; Zahouily, M.; Abdelouahdi, K.; Barakat, A.; Solhy, A. Synergistic effect of cellulose nanocrystals/graphene oxide nanosheets as functional hybrid nanofiller for enhancing properties of PVA nanocomposites. Carbohydr. Polym. 2016, 137, 239-248.
82. Šturcová, A.; Davies, G. R.; Eichhorn, S. J. Elastic modulus and stress-transfer properties of tunicate cellulose whiskers. Biomacromolecules 2005, 6, 1055-1061.
83. Rusli, R.; Shanmuganathan, K.; Rowan, S. J.; Weder, C.; Eichhorn, S. J. Stress Transfer in Cellulose Nanowhisker Composites—Influence of Whisker Aspect Ratio and Surface Charge. Biomacromolecules 2011, 12, 1363.
84. Natarajan, B. Binary cellulose nanocrystal blends for bioinspired damage tolerant photonic films. Adv Funct Mater 2018, 28.
85. Natarajan, B. N.; Krishnamurthy, A.; Emiroglu, C. D.; Forster, A. L.; Foster, E. J.; Weder, C.; Fox, D. M.; Obrzut, J.; Gilman, J. W. Hierarchical Cellulose Nanocrystal Blends for Bioinspired Damage Tolerant Photonic Films. Adv Mater 2018, 28.
86. Dunlop, M. J.; Clemons, C.; Reiner, R.; Sabo, R.; Agarwal, U. P.; Bissessur, R.; Sojoudiasli, H.; Carreau, P. J.; Acharya, B. Towards the scalable isolation of cellulose nanocrystals from tunicates. Scientific reports 2020, 10, 1-13.
87. Mukherjee, S. M.; Woods, H. J. X-ray and electron microscope studies of the degradation of cellulose by sulphuric acid. Biochim. Biophys. Acta 1953, 10, 499-511.
88. De Souza Lima, M M [symbol] ; Wong, J. T.; Paillet, M. [symbol] ; Borsali, R.; Pecora, R. Translational and rotational dynamics of rodlike cellulose whiskers. Langmuir 2003, 19, 24-29.
89. de Souza Lima, M Miriam; Borsali, R. Static and dynamic light scattering from polyelectrolyte microcrystal cellulose. Langmuir 2002, 18, 992-996.
90. Beltrame, P. L.; Paglia, E. D.; Seves, A.; Pellizzoni, E.; Romanò, M. Structural features of native cellulose gels and films from their susceptibility to enzymic attack. J Appl Polym Sci 1992, 44, 2095-2101.
91. Hol, H. R.; Jehli, J. The presence of cellulose microfibrils in the proteinaceous slime track of Dictyostelium discoideum. Archiv für Mikrobiologie 1973, 92, 179-187.
92. Al-Dulaimi, A. A.; Wanrosli, W. D. Isolation and characterization of nanocrystalline cellulose from totally chlorine free oil palm empty fruit bunch pulp. Journal of Polymers and the Environment 2017, 25, 192-202.
93. Ditzel, F. I.; Prestes, E.; Carvalho, B. M.; Demiate, I. M.; Pinheiro, L. A. Nanocrystalline cellulose extracted from pine wood and corncob. Carbohydr. Polym. 2017, 157, 1577-1585.
94. Rohaizu, R.; Wanrosli, W. D. Sono-assisted TEMPO oxidation of oil palm lignocellulosic biomass for isolation of nanocrystalline cellulose. Ultrason. Sonochem. 2017, 34, 631-639.
95. Brinchi, L.; Cotana, F.; Fortunati, E.; Kenny, J. M. Production of nanocrystalline cellulose from lignocellulosic biomass: technology and applications. Carbohydr. Polym. 2013, 94, 154-169.
96. Clift, M. J. D.; Foster, E. J.; Vanhecke, D.; Studer, D.; Wick, P.; Gehr, P.; Rothen-Rutishauser, B.; Weder, C. Investigating the Interaction of Cellulose Nanofibers Derived from Cotton with a Sophisticated 3D Human Lung Cell Coculture. Biomacromolecules 2011, 12, 3666-3673.
97. Eichhorn, S. J.; Dufresne, A.; Aranguren, M.; Marcovich, N. E.; Capadona, J. R.; Rowan, S. J.; Weder, C.; Thielemans, W.; Roman, M.; Renneckar, S.; Gindl, W.; Veigel, S.; Keckes, J.; Yano, H.; Abe, K.; Nogi, M.; Nakagaito, A. N.; Mangalam, A.; Simonsen, J.; Benight, A. S.; Bismarck, A.; Berglund, L. A.; Peijs, T. Review: current international research into cellulose nanofibres and nanocomposites. J. Mater. Sci. 2010, 45, 1-33.
98. Fukuzumi, H.; Saito, T.; Iwata, T.; Kumamoto, Y.; Isogai, A. Transparent and High Gas Barrier Films of Cellulose Nanofibers Prepared by TEMPO-Mediated Oxidation. Biomacromolecules 2009, 10, 162-165.
99. Kelly, J. A.; Shukaliak, A. M.; Cheung, C. C. Y.; Shopsowitz, K. E.; Hamad, W. Y.; MacLachlan, M. J. Responsive Photonic Hydrogels Based on Nanocrystalline Cellulose. Angewandte Chemie International Edition 2013, 52, 8912-8916.
100. Mendez, J.; Annamalai, P. K.; Eichhorn, S. J.; Rusli, R.; Rowan, S. J.; Foster, E. J.; Weder, C. Bioinspired Mechanically Adaptive Polymer Nanocomposites with Water-Activated Shape-Memory Effect. Macromolecules 2011, 44, 6827-6835.
101. Biyani, M. V.; Foster, E. J.; Weder, C. Light-Healable Supramolecular Nanocomposites Based on Modified Cellulose Nanocrystals. ACS Macro Lett. 2013, 2, 236-240.
102. Potter, K. A.; Jorfi, M.; Householder, K. T.; Foster, E. J.; Weder, C.; Capadona, J. R. Curcumin-releasing mechanically adaptive intracortical implants improve the proximal neuronal density and blood-brain barrier stability. Acta biomaterialia 2014, 10, 2209-2222.
103. Capadona, J. R.; Tyler, D. J.; Zorman, C. A.; Rowan, S. J.; Weder, C. Mechanically adaptive nanocomposites for neural interfacing. MRS Bulletin 2012, 37, 581-589.
104. Ma, H.; Hsiao, B. S.; Chu, B. Ultrafine Cellulose Nanofibers as Efficient Adsorbents for Removal of UO22+ in Water. ACS Macro Lett. 2012, 1, 213-216.
105. Trache, D.; Hussin, M. H.; Haafiz, M. M.; Thakur, V. K. Recent progress in cellulose nanocrystals: sources and production. Nanoscale 2017, 9, 1763-1786.
106. Troedsson, C.; Thompson, E.; Bouquet, J.; Magnesen, T.; Schander, C.; Li, J. WO Patent WO2013088177A1, 2013.
107. Locke, A.; Carman, M. Market potential for Styela clava, a non-indigenous pest invading New England coastal waters. Aquatic Invasions 2009, 4, 295-297.
108. Locke, A.; Doe, K. G.; Fairchild, W. L.; Jackman, P. M.; Reese, E.; Carman, M. R. In In Preliminary evaluation of effects of invasive tunicate management with acetic acid and calcium hydroxide on non-target marine organisms in Prince Edward Island, Canada; 2009.
109. Filgueira, R.; Strople, L. C.; Strohmeier, T.; Rastrick, S.; Strand, Ø Mussels or tunicates: That is the question. Evaluating efficient and sustainable resource use by low-trophic species in aquaculture settings. Journal of Cleaner Production 2019, 231, 132-143.
110. Hassanzadeh, M. Composition and Application Potentials of Scandinavian Tunicates; KTH, School of Chemical Science and Engineering (CHE), Fibre and Polymer Technology.: 2011; pp 69.
111. Koo, Y.; Wang, Y.; You, S.; Kim, H. Preparation and properties of chemical cellulose from ascidian tunic and their regenerated cellulose fibers. Journal of Applied Polymer Science 2002, 85, 1634-1643.
112. Swinehart, J. H.; Biggs, W. R.; Halko, D. J.; Schroeder, N. C. The vanadium and selected metal contents of some ascidians. Biol. Bull. 1974, 146.
113. Hamad, W. Y.; Hu, T. Q. Structure-process-yield interrelations in nanocrystalline cellulose extraction. The Canadian Journal of Chemical Engineering 2010, 88, 392-402.
114. Samzadeh-Kermani, A.; Esfandiary, N. Synthesis and characterization of new biodegradable chitosan/polyvinyl alcohol/cellulose nanocomposite. Advances in Nanoparticles 2016, 5, 18.
115. Favier, V.; Chanzy, H.; Cavaillé, J. Polymer nanocomposites reinforced by cellulose whiskers. Macromolecules 1995, 28, 6365-6367.
116. Foster, E. J.; Moon, R. J.; Agarwal, U. P.; Bortner, M. J.; Bras, J.; Camarero-Espinosa, S.; Chan, K. J.; Clift, M. J.; Cranston, E. D.; Eichhorn, S. J. Current characterization methods for cellulose nanomaterials. Chem. Soc. Rev. 2018, 47, 2609-2679.
117. Brinchi, L. Production of nanocrystalline cellulose from lignocellulosic biomass: technology and applications. Carbohydr. Polym. 2013, 94.
118. Kumar, A.; Negi, Y. S.; Choudhary, V.; Bhardwaj, N. K. In In Characterization of Cellulose Nanocrystals Produced by Acid-Hydrolysis from Sugarcane Bagasse as Agro-Waste; 2014.
119. Bondeson, D. Optimization of the isolation of nanocrystals from microcrystalline cellulose by acid hydrolysis. Cellulose 2006, 13.
120. Camarero Espinosa, S. Isolation of thermally stable cellulose nanocrystals by phosphoric acid hydrolysis. Biomacromol 2013, 14.
121. Eyley, S.; Thielemans, W. Surface modification of cellulose nanocrystals. Nanoscale 2014, 6, 7764. 122. Missoum, K. Nanofibrillated cellulose surface modification: a review. Materials 2013, 6.
123. Kvien, I.; Tanem, B. S.; Oksman, K. Characterization of cellulose whiskers and their nanocomposites by atomic force and electron microscopy. Biomacromolecules 2005, 6.
124. Dong, H. Cellulose nanocrystals as a reinforcing material for electrospun poly (methyl methacrylate) fibers: formation, properties and nanomechanical characterization. Carbohyd Polym 2012, 87.
125. Chazeau, L. Plasticized PVC reinforced with cellulose whiskers. II. Plastic behavior. J Polym Sci Pol Phys 2000, 38.
126. Li, W.; Yue, J.; Liu, S. Preparation of nanocrystalline cellulose via ultrasound and its reinforcement capability for poly (vinyl alcohol) composites. Ultrason. Sonochem. 2012, 19.
127. Pereira, A. L. Improvement of polyvinyl alcohol properties by adding nanocrystalline cellulose isolated from banana pseudostems. Carbohyd Polym 2014, 112.
128. Saxena, A. Moisture barrier properties of xylan composite films. Carbohyd Polym 2011, 84.
129. Rojas, O. J. Electrospun nanocomposites from polystyrene loaded with cellulose nanowhiskers. J Appl Poly Sci 2009, 113.
130. Auad, M. Shape memory segmented polyurethanes: dependence of behavior on nanocellulose addition and testing conditions. Polym. Int. 2012, 61.
131. Jean, B. Structural details of cellulose nanocrystals/polyelectrolytes multilayers probed by neutron reflectivity and AFM. Langmuir 2008, 24.
132. Šturcová, A.; Davies, G. R.; Eichhorn, S. J. Elastic modulus and stress-transfer properties of tunicate cellulose whiskers. Biomacromolecules 2005, 6, 1055.
133. Mutiso, R. M.; Winey, K. I. Electrical percolation in quasi-two-dimensional metal nanowire networks for transparent conductors. Physical Review E 2013, 88, 032134.
134. Otten, R. H.; van der Schoot, P. Connectivity percolation of polydisperse anisotropic nanofillers. J. Chem. Phys. 2011, 134, 094902.
135. Shanmuganathan, K. Bio-inspired mechanically-adaptive nanocomposites derived from cotton cellulose whiskers. J Mat Chem 2010, 20.
136. Shanmuganathan, K.; Capadona, J. R.; Rowan, S. J.; Weder, C. Stimuli-Responsive Mechanically Adaptive Polymer Nanocomposites. ACS Appl. Mater. Interfaces 2010, 2, 165-174.
137. Goel, A. Two-dimensional microstructure based modelling of Young's modulus of long fibre thermoplastic composite. Mater Sci Tech Ser 2008, 24.
138. Chawla, K. K. Composite materials: science and engineering; Springer: Berlin, 2012.
139. Li, V. C.; Kuang, X.; Mulyadi, A.; Hamel, C. M.; Deng, Y.; Qi, H. J. 3D printed cellulose nanocrystal composites through digital light processing. Cellulose 2019, 26, 3973-3985.
140. Xu, X. Cellulose nanocrystals vs. cellulose nanofibrils: a comparative study on their microstructures and effects as polymer reinforcing agents. ACS Appl Mater Interfaces 2013, 5.
141. Dufresne, A. Nanocellulose: from nature to high performance tailored materials; Co KG: Berlin, 2017.
142. Natarajan, B.; Gilman, J. W. Bioinspired Bouligand cellulose nanocrystal composites: a review of mechanical properties. Philos Trans R Soc A Math Phys Eng Sci 2017, 376.
143. Beuguel, Q.; Tavares, J. R.; Carreau, P. J.; Heuzey, M. -. Rheological behavior of cellulose nanocrystal suspensions in polyethylene glycol. J. Rheol. 2018, 62, 607.
144. Beuguel, Q. Ultrasonication of spray-and freeze-dried cellulose nanocrystals in water. J Colloid Interf Sci 2018, 516.
145. Jorfi, M.; Roberts, M. N.; Foster, E. J.; Weder, C. Physiologically responsive, mechanically adaptive bio-nanocomposites for biomedical applications. ACS Appl Mater Interfaces 2013, 5.
146. Wang, Y. Role of starch nanocrystals and cellulose whiskers in synergistic reinforcement of waterborne polyurethane. Carbohyd Polym 2010, 80.
147. Kumar, A. Characterization of cellulose nanocrystals produced by acid-hydrolysis from sugarcane bagasse as agro-waste. Mater Phys Chem 2014, 2.
148. Popescu, M. -. C. Structure and sorption properties of CNC reinforced PVA films. Int. J. Biol. Macromol. 2017, 101.
149. Sánchez-Silva, L. Tailor-made aerogels based on carbon nanofibers by freeze-drying. Sci Adv Mater 2014, 6.
150. Raju, C. L. Thermal and IR studies on copper doped polyvinyl alcohol. B Mater Sci 2007, 30.
151. Pojanavaraphan, T. Mechanical, rheological, and swelling behavior of natural rubber/montmorillonite aerogels prepared by freeze-drying. Appl. Clay. Sci. 2010, 50.
152. Guirguis, O. W.; Moselhey, M. T. Thermal and structural studies of poly (vinyl alcohol) and hydroxypropyl cellulose blends. Nat Sci 2012, 4.
153. Bai, Q. Thermal and water dual-responsive shape memory poly (vinyl alcohol)/Al2O3 nanocomposite. RSC Adv 2015, 5.
154. Miao, X. Tuning the mechanical properties of cellulose nanofibrils reinforced polyvinyl alcohol composites via altering the cellulose polymorphs. RSC Adv 2016, 6.
155. AnonymousChen S (2015) Experimental and modeling investigation of cellulose nanocrystals polymer composite fiber. Purdue University. Open access dissertations. p 435. https://docs.lib.purdue.edu/open_access_dissertations/435.
156. Chen, L.; Wang, Q.; Hirth, K.; Baez, C.; Agarwal, U. P.; Zhu, J. Y. Tailoring the yield and characteristics of wood cellulose nanocrystals (CNC) using concentrated acid hydrolysis. Cellulose 2015, 22, 1753-1762.
157. Bouligand, Y. Twisted fibrous arrangements in biological materials and cholesteric mesophases. Tissue Cell 1972, 4.
158. Bajpai, P. K.; Singh, I.; Madaan, J. Development and characterization of PLA-based green composites: A review. J. Thermoplast. Compos. Mater. 2014, 27, 52-81.
159. Williams, C. K.; Hillmyer, M. A. Polymers from renewable resources: a perspective for a special issue of polymer reviews. Polymer reviews 2008, 48, 1-10.
160. Alavi, S.; Thomas, S.; Sandeep, K. P.; Kalarikkal, N.; Varghese, J.; Yaragalla, S. Polymers for packaging applications; CRC Press: 2014.
161. Cheng, Y.; Deng, S.; Chen, P.; Ruan, R. Polylactic acid (PLA) synthesis and modifications: a review. Frontiers of chemistry in China 2009, 4, 259-264.
162. Rocca-Smith, J. R.; Chau, N.; Champion, D.; Brachais, C.; Marcuzzo, E.; Sensidoni, A.; Piasente, F.; Karbowiak, T.; Debeaufort, F. Effect of the state of water and relative humidity on ageing of PLA films. Food Chem. 2017, 236, 109-119.
163. Iñiguez-Franco, F.; Auras, R.; Rubino, M.; Dolan, K.; Soto-Valdez, H.; Selke, S. Effect of nanoparticles on the hydrolytic degradation of PLA-nanocomposites by water-ethanol solutions. Polym. Degrad. Stab. 2017, 146, 287-297.
164. Bitinis, N.; Fortunati, E.; Verdejo, R.; Bras, J.; Kenny, J. M.; Torre, L.; López-Manchado, M. A. Poly (lactic acid)/natural rubber/cellulose nanocrystal bionanocomposites. Part II: Properties evaluation. Carbohydr. Polym. 2013, 96, 621-627.
165. Wei, L.; Luo, S.; McDonald, A. G.; Agarwal, U. P.; Hirth, K. C.; Matuana, L. M.; Sabo, R. C.; Stark, N. M. Preparation and Characterization of the Nanocomposites from Chemically Modified Nanocellulose and Poly (lactic acid). Journal of Renewable Materials 2017, 5.
166. Wei, L.; Agarwal, U. P.; Matuana, L.; Sabo, R. C.; Stark, N. M. Performance of high lignin content cellulose nanocrystals in poly(lactic acid). Polymer 2018, 135, 305-313.
167. Fortunati, E.; Luzi, F.; Puglia, D.; Dominici, F.; Santulli, C.; Kenny, J. M.; Torre, L. Investigation of thermo-mechanical, chemical and degradative properties of PLA-limonene films reinforced with cellulose nanocrystals extracted from Phormium tenax leaves. European Polymer Journal 2014, 56, 77-91.
168. Salmieri, S.; Islam, F.; Khan, R. A.; Hossain, F. M.; Ibrahim, H. M.; Miao, C.; Hamad, W. Y.; Lacroix, M. Antimicrobial nanocomposite films made of poly (lactic acid)-cellulose nanocrystals (PLA-CNC) in food applications—part B: effect of oregano essential oil release on the inactivation of Listeria monocytogenes in mixed vegetables. Cellulose 2014, 21, 4271-4285.
169. Salmieri, S.; Islam, F.; Khan, R. A.; Hossain, F. M.; Ibrahim, H. M.; Miao, C.; Hamad, W. Y.; Lacroix, M. Antimicrobial nanocomposite films made of poly (lactic acid)-cellulose nanocrystals (PLA-CNC) in food applications: part A-effect of nisin release on the inactivation of Listeria monocytogenes in ham. Cellulose 2014, 21, 1837-1850.
170. Kamal, M. R.; Khoshkava, V. Effect of cellulose nanocrystals (CNC) on rheological and mechanical properties and crystallization behavior of PLA/CNC nanocomposites. Carbohydr. Polym. 2015, 123, 105-114.
171. Bindu, J.; Kumar, K. S.; Panda, S. K.; Katiyar, V. Biopolymer Dispersed Poly Lactic Acid Composites and Blends for Food Packaging Applications. In Advances in Sustainable Polymers Springer: 2019; pp 209-235.
172. Panchal, P.; Ogunsona, E.; Mekonnen, T. Trends in Advanced Functional Material Applications of Nanocellulose. Processes 2019, 7.
173. Zheng, T.; Pilla, S. Melt Processing of Cellulose Nanocrystal Filled Composites: Towards Reinforcement and Foam Nucleation. Ind. Eng. Chem. Res. 2020.
174. Hu, Z.; Berry, R. M.; Pelton, R.; Cranston, E. D. One-pot water-based hydrophobic surface modification of cellulose nanocrystals using plant polyphenols. ACS Sustainable Chemistry & Engineering 2017, 5, 5018-5026.
175. SigmaAldrich Octadecylamine Product Information: O1408-3KG. https://www.sigmaaldrich.com/catalog/product/aldrich/o1408?lang=en&region=CA (accessed January 2021).
176. Natarajan, B.; Krishnamurthy, A.; Qin, X.; Emiroglu, C. D.; Forster, A.; Foster, E. J.; Weder, C.; Fox, D. M.; Keten, S.; Obrzut, J. Binary cellulose nanocrystal blends for bioinspired damage tolerant photonic films. Advanced Functional Materials 2018, 28, 1800032.
177. Karkhanis, S. S.; Stark, N. M.; Sabo, R. C.; Matuana, L. M. Performance of poly (lactic acid)/cellulose nanocrystal composite blown films processed by two different compounding approaches. Polymer Engineering & Science 2018, 58, 1965-1974.
178. Wu, Q.; Meng, Y.; Wang, S.; Li, Y.; Fu, S.; Ma, L.; Harper, D. Rheological behavior of cellulose nanocrystal suspension: Influence of concentration and aspect ratio. Journal of Applied Polymer Science 2014, 131.
179. Sabo, R. C.; Stark, N. M.; Wei, L.; Matuana, L. M. In In Wet compounding of cellulose nanocrystals into polylactic acid for packaging applications; ANTEC 2019—the plastics conference. 5 p. 2019; pp 1-5.
180. Peng, J.; Walsh, P. J.; Sabo, R. C.; Turng, L. -.; Clemons, C. M. Water-assisted compounding of cellulose nanocrystals into polyamide 6 for use as a nucleating agent for microcellular foaming. Polymer 2016, 84, 158.
181. Karkhanis, S. S.; Stark, N. M.; Sabo, R. C.; Matuana, L. M. Water vapor and oxygen barrier properties of extrusion-blown poly (lactic acid)/cellulose nanocrystals nanocomposite films. Composites Part A: Applied Science and Manufacturing 2018, 114, 204-211.
182. Jeon, H. J.; Kim, M. N. Biodegradation of poly (L-lactide) (PLA) exposed to UV irradiation by a mesophilic bacterium. Int. Biodeterior. Biodegrad. 2013, 85, 289-293.
183. Bubpachat, T.; Sombatsompop, N.; Prapagdee, B. Isolation and role of polylactic acid-degrading bacteria on degrading enzymes productions and PLA biodegradability at mesophilic conditions. Polymer Degradation and Stability 2018, 152, 75-85.
184. Fumagalli, M.; Ouhab, D.; Boisseau, S. M.; Heux, L. Versatile Gas-Phase Reactions for Surface to Bulk Esterification of Cellulose Microfibrils Aerogels. Biomacromolecules 2013, 14, 3246-3255.
185. Wang, Z.; Xu, Y.; Liu, Y.; Shao, L. A novel mussel-inspired strategy toward superhydrophobic surfaces for self-driven crude oil spill cleanup. J. Mater. Chem. A 2015, 3, 12171-12178.
186. Roman, M.; Winter, W. T. Effect of Sulfate Groups from Sulfuric Acid Hydrolysis on the Thermal Degradation Behavior of Bacterial Cellulose. Biomacromolecules 2004, 5, 1671-1677.
187. Sabo, R. C.; Stark, N. M.; Lebow, P.; Nabinejad, O.; Karkhanis, S. S.; Matuana, L. M. In In Novel method of compounding cellulose nanocrystal suspensions into poly (lactic acid) and poly (vinyl acetate) blends; In: Society of Plastics Engineers Annual Technical Conference (ANTEC 2020). 2020; pp 1-7.
188. Siqueira, G.; Bras, J.; Dufresne, A. Cellulosic bionanocomposites: a review of preparation, properties and applications. Polymers 2010, 2, 728-765.
189. Suryanegara, L.; Nakagaito, A. N.; Yano, H. The effect of crystallization of PLA on the thermal and mechanical properties of microfibrillated cellulose-reinforced PLA composites. Composites Sci. Technol. 2009, 69, 1187-1192.
190. Du, Y.; Wu, T.; Yan, N.; Kortschot, M. T.; Farnood, R. Fabrication and characterization of fully biodegradable natural fiber-reinforced poly (lactic acid) composites. Composites Part B: Engineering 2014, 56, 717-723.
191. Frone, A. N.; Berlioz, S.; Chailan, J.; Panaitescu, D. M. Morphology and thermal properties of PLA-cellulose nanofibers composites. Carbohydr. Polym. 2013, 91, 377-384.
192. Kang, K. S.; Lee, S. I.; Lee, T. J.; Narayan, R.; Shin, B. Y. Effect of biobased and biodegradable nucleating agent on the isothermal crystallization of poly (lactic acid). Korean Journal of Chemical Engineering 2008, 25, 599.
193. Dunlop, M. J.; Bissessur, R. Nanocomposites based on graphene analogous materials and conducting polymers: a review. J. Mater. Sci. 2020, 55, 6721-6753.
194. Nature Works Ingeo™ Biopolymer 4044D Technical Data Sheet Reactive Extrusion Grade. https://www.natureworksllc.com/˜/media/Files/NatureWorks/Technical-Documents/Technical-Data-Sheets/TechnicalDataSheet 4044D films_pdf.pdf (accessed January 2021).
195. Ghosh, T.; Dhar, P.; Katiyar, V. 6 Nanocellulose for food packaging applications. Cellulose Nanocrystals 2020, 157.
196. Cheng, Y.; Mondal, A. K.; Wu, S.; Xu, D.; Ning, D.; Ni, Y.; Huang, F. Study on the Anti-Biodegradation Property of Tunicate Cellulose. Polymers 2020, 12, 3071.
197. Dumanli, A. G.; Kamita, G.; Landman, J.; Kooij, H. v. d.; Glover, B. J.; Baumberg, J. J.; Steiner, U.; Vignolini, S. Controlled, Bio-inspired Self-Assembly of Cellulose-Based Chiral Reflectors. Advanced Optical Materials 2014, 2, 646-650.
198. An, X.; Long, Y.; Ni, Y. Cellulose nanocrystal/hexadecyltrimethylammonium bromide/silver nanoparticle composite as a catalyst for reduction of 4-nitrophenol. Carbohydr. Polym. 2017, 156, 253-258.
199. Mautner, A.; Lee, K.; Lahtinen, P.; Hakalahti, M.; Tammelin, T.; Li, K.; Bismarck, A. Nanopapers for organic solvent nanofiltration. Chemical Communications 2014, 50, 5778-5781.
200. Domingues, R. M.; Gomes, M. E.; Reis, R. L. The potential of cellulose nanocrystals in tissue engineering strategies. Biomacromolecules 2014, 15, 2327-2346.
201. Kabir, A.; Dunlop, M. J.; Acharya, B.; Bissessur, R.; Ahmed, M. Polymeric composites with embedded nanocrystalline cellulose for the removal of iron (II) from contaminated water. Polymers 2018, 10, 1377.
202. Park, C.; Han, S.; Namgung, H. Overview of the Preparation Methods of Nano-scale Cellulose. Journal of Korea TAPPI 2017, 49, 9-17p.
203. Miller, J. Cellulose Nanomaterials: State of the Industry The Road to Commercialization. PAPER DAYS 2017 2017.
204. Peng, B. L.; Dhar, N.; Liu, H. L.; Tam, K. C. Chemistry and applications of nanocrystalline cellulose and its derivatives: a nanotechnology perspective. The Canadian Journal of Chemical Engineering 2011, 89, 1191-1206.
205. Trache, D.; Tarchoun, A. F.; Derradji, M.; Hamidon, T. S.; Masruchin, N.; Brosse, N.; Hussin, M. H. Nanocellulose: from fundamentals to advanced applications. Frontiers in Chemistry 2020, 8, 392.
206. Wu, Q.; Li, X.; Fu, S.; Li, Q.; Wang, S. Estimation of aspect ratio of cellulose nanocrystals by viscosity measurement:influence of surface charge density and NaCl concentration. Cellulose 2017, 24, 3255-3264.
207. van den Berg, O.; Capadona, J. R.; Weder, C. Preparation of Homogeneous Dispersions of Tunicate Cellulose Whiskers in Organic Solvents. Biomacromolecules 2007, 8, 1353-1357.
208. Cao, L.; Fu, X.; Xu, C.; Yin, S.; Chen, Y. High-performance natural rubber nanocomposites with marine biomass (tunicate cellulose). Cellulose 2017, 24, 2849-2860.
209. Favier, V.; Chanzy, H.; Cavaille, J. Y. Polymer Nanocomposites Reinforced by Cellulose Whiskers. Macromolecules 1995, 28, 6365-6367.
210. Iwamoto, S.; Kai, W.; Isogai, A.; Iwata, T. Elastic modulus of single cellulose microfibrils from tunicate measured by atomic force microscopy. Biomacromolecules 2009, 10, 2571-2576.
211. Zhang, T.; Cheng, Q.; Ye, D.; Chang, C. Tunicate cellulose nanocrystals reinforced nanocomposite hydrogels comprised by hybrid cross-linked networks. Carbohydrate Polymers 2017, 169, 139-148.
212. Schroers, M.; Kokil, A.; Weder, C. Solid polymer electrolytes based on nanocomposites of ethylene oxide-epichlorohydrin copolymers and cellulose whiskers. J Appl Polym Sci 2004, 93, 2883-2888.
213. Shanmuganathan, K.; Capadona, J. R.; Rowan, S. J.; Weder, C. Bio-inspired mechanically-adaptive nanocomposites derived from cotton cellulose whiskers. J. Mater. Chem. 2010, 20, 180.
214. Bercea, M.; Navard, P. Shear Dynamics of Aqueous Suspensions of Cellulose Whiskers. Macromolecules 2000, 33, 6011-6016.
215. Ramsay, A.; Davidson, J.; Landry, T.; Arsenault, G. Process of invasiveness among exotic tunicates in Prince Edward Island, Canada. Biol. Invasions 2008, 10, 1311-1316.
216. LeBlanc, N.; Davidson, J.; Tremblay, R.; McNiven, M.; Landry, T. The effect of anti-fouling treatments for the clubbed tunicate on the blue mussel, Mytilus edulis. Aquaculture 2007, 264, 205-213.
217. Guyondet, T.; Patanasatienkul, T.; Comeau, L. A.; Landry, T.; Davidson, J. Preliminary model of tunicate infestation impacts on seston availability and organic sedimentation in longline mussel farms. Aquaculture 2016, 465, 387-394.
218. Government of Canada, Fisheries and Oceans Statistical Services Canadian Aquaculture Production Statistics, 2018|Fisheries and Oceans Canada. https://www.dfo-mpo.gc.ca/stats/aqua/aqua18-eng.htm (accessed Apr. 22, 2020).
219. Government of Canada, Fisheries and Oceans Canada Canadian Aquaculture R&D Review 2009. https://www.dfo-mpo.gc.ca/aquaculture/sci-res/rd2009/shell-eng.html (accessed Apr. 22, 2020).
220. Davidson, J. D.; Landry, T.; Johnson, G. R.; Quijon, P. A. A cost-benefit analysis of four treatment regimes for the invasive tunicate Ciona intestinalis on mussel farms. Management of Biological Invasions 2017, 8, 163-170.
221. McKindsey, C. W.; Lecuona, M.; Huot, M.; Weise, A. M. Biodeposit production and benthic loading by farmed mussels and associated tunicate epifauna in Prince Edward Island. Aquaculture 2009, 295, 44-51.
222. Stoecker, D. Resistance of a tunicate to fouling. Biol. Bull. 1978, 155.
223. Christofer, T.; Eric, T.; Christoffer, S.; Jean-Marie, B.; Thorolf, M.; Jiebing, L. U.S. Pat. No. 10,226,032B2, 2019.
224. Zhao, Y.; Zhang, Y.; Lindstrom, M. E.; Li, J. Tunicate cellulose nanocrystals: preparation, neat films and nanocomposite films with glucomannans. Carbohydr. Polym. 2015, 117, 286-296.
225. Morris, R. H.; Abbott, D. P.; Haderlie, E. C. Intertidal Invertebrates of California Stanford University Press Stanford. 1980.
226. Clarke, C. L.; Therriault, T. W. Biological synopsis of the invasive tunicate Styela clava (Herdman 1881); Fisheries and Oceans Canada, Science Branch, Pacific Region, Pacific . . . : 2007.
227. Belton, P. S.; Tanner, S. F.; Cartier, N.; Chanzy, H. High-resolution solid-state carbon-13 nuclear magnetic resonance spectroscopy of tunicin, an animal cellulose. Macromolecules 1989, 22, 1615-1617.
228. Yuan, H.; Nishiyama, Y.; Wada, M.; Kuga, S. Surface acylation of cellulose whiskers by drying aqueous emulsion. Biomacromolecules 2006, 7, 696-700.
229. Darpentigny, C.; Molina-Boisseau, S.; Nonglaton, G.; Bras, J.; Jean, B. Ice-templated freeze-dried cryogels from tunicate cellulose nanocrystals with high specific surface area and anisotropic morphological and mechanical properties. Cellulose 2020, 27, 233-247.
230. Cheng, Q.; Ye, D.; Chang, C.; Zhang, L. Facile fabrication of superhydrophilic membranes consisted of fibrous tunicate cellulose nanocrystals for highly efficient oil/water separation. Journal of Membrane Science 2017, 525, 1-8.
231. Zhang, Y.; Cheng, Q.; Chang, C.; Zhang, L. Phase transition identification of cellulose nanocrystal suspensions derived from various raw materials. Journal of Applied Polymer Science 2018, 135, 45702.
232. Hultin, H. O.; Kelleher, S. D. U.S. Pat. No. 6,136,959A, 2000.
233. Ruppert, E. E.; Fox, R. S.; Barnes, R. D. Invertebrate zoology: a functional evolutionary approach; Thomson-Brooks/Cole: Belmont, CA, 2004; pp 963, 26.
234. Brand, S. G.; Hawkins, C. J.; Marshall, A. T.; Nette, G. W.; Parry, D. L. Vanadium chemistry of ascidians. Comp. Biochem. Physiol. 1989, 93B.
235. Dingley, A. L.; Kustin, K.; Macara, I. G.; McLeod, G. C.; Roberts, M. F. Vanadium-containing tunicate blood cells are not highly acidic. Biochim. Biophys. Acta 1982, 720.
236. Webb, D. A. Observations on the blood of certain ascidians, with special reference to the biochemistry of vanadium. J. Exp. Biol. 1939, 16.
237. Yu, H.; Qin, Z.; Liang, B.; Liu, N.; Zhou, Z.; Chen, L. Facile extraction of thermally stable cellulose nanocrystals with a high yield of 93% through hydrochloric acid hydrolysis under hydrothermal conditions. Journal of Materials Chemistry A 2013, 1, 3938-3944.
238. Reid, M. S.; Villalobos, M.; Cranston, E. D. Benchmarking cellulose nanocrystals: from the laboratory to industrial production. Langmuir 2017, 33, 1583-1598.
239. Redondo, A.; Chatterjee, S.; Brodard, P.; Korley, L. T.; Weder, C.; Gunkel, I.; Steiner, U. Melt-Spun Nanocomposite Fibers Reinforced with Aligned Tunicate Nanocrystals. Polymers 2019, 11, 1912.
240. Lenfant, G.; Heuzey, M.; van de Ven, Theo G M; Carreau, P. J. A comparative study of ECNC and CNC suspensions: effect of salt on rheological properties. Rheologica Acta 2017, 56, 51-62.
241. Sojoudiasli, H.; Heuzey, M.; Carreau, P. J.; Riedl, B. Rheological behavior of suspensions of modified and unmodified cellulose nanocrystals in dimethyl sulfoxide. Rheologica Acta 2017, 56, 673-682.
242. Xu, Y.; Atrens, A.; Stokes, J. R. Advances in colloid and interface science. Advances in colloid and interface science 2019, 269, 309-333.
243. Moberg, T.; Sahlin, K.; Yao, K.; Geng, S.; Westman, G.; Zhou, Q.; Oksman, K.; Rigdahl, M. Rheological properties of nanocellulose suspensions: effects of fibril/particle dimensions and surface characteristics. Cellulose 2017, 24, 2499-2510.
244. Reiner, R. S.; Rudie, A. W. Pilot plant scale-up of TEMPO-pretreated cellulose nanofibrils. Production and applications of cellulose nanomaterials 2013, 177-178.
245. Fernandes Diniz, J. M. B.; Gil, M. H.; Castro, J. A. A. M. Hornification-its origin and interpretation in wood pulps. Wood Sci. Technol. 2004, 37, 489-494.
246. Agarwal, U. P. Raman Spectroscopy in the Analysis of Cellulose Nanomaterials. In Nanocelluloses: Their Preparation, Properties, and Applications American Chemical Society: 2017; Vol. 1251, pp 75-90.
247. George, J.; Sajeevkumar, V. A.; Kumar, R.; Ramana, K. V.; Sabapathy, S. N.; Bawa, A. S. Enhancement of thermal stability associated with the chemical treatment of bacterial (Gluconacetobacter xylinus) cellulose. Journal of Applied Polymer Science 2008, 108, 1845-1851.
248. Nicharat, A.; Sapkota, J.; Weder, C.; Foster, E. J. Melt processing of polyamide 12 and cellulose nanocrystals nanocomposites. J Appl Polym Sci 2015, 132, 42752.
249. Jun, S. Y.; Park, J.; Song, H.; Shin, H. Tunicate Cellulose Nanocrystals as Stabilizers for PLGA-based Polymeric Nanoparticles. Biotechnology and Bioprocess Engineering 2020, 25, 206-214.
250. Agarwal, U. P.; Reiner, R. S.; Ralph, S. A. Cellulose I crystallinity determination using FT-Raman spectroscopy: univariate and multivariate methods. Cellulose 2010, 17, 721-733.
251. Agarwal, U. P.; Reiner, R. R.; Ralph, S. A. Estimation of Cellulose Crystallinity of Lignocelluloses Using Near-IR FT-Raman Spectroscopy and Comparison of the Raman and Segal-WAXS Methods. J. Agric. Food Chem. 2013, 61, 103-113.
252. Agarwal, U. P.; Ralph, S. A.; Reiner, R. S.; Baez, C. New cellulose crystallinity estimation method that differentiates between organized and crystalline phases. Carbohydr. Polym. 2018, 190, 262-270.
253. Agarwal, U. P.; Ralph, S. A.; Reiner, R. S.; Baez, C. Probing crystallinity of never-dried wood cellulose with Raman spectroscopy. Cellulose 2016, 23, 125-144.
254. Ioelovich, M. Waste free Technologies for Production of Nanocrystalline Cellulose and its Composites Corresponding author. Advances in Environmental Research 2020, 3, 128.
255. Ioelovich, M. Zero-discharge technology for production of nanocrystalline cellulose. J. NanoSci. Eng 2017, 1, 29-33.
256. Spinella, S.; Samuel, C.; Raquez, J. -.; McCallum, S. A.; Gross, R.; Dubois, P. Green and efficient synthesis of dispersible cellulose nanocrystals in biobased polyesters for engineering applications. ACS Sustainable Chem. Eng. 2016, 4, 2517.
257. Novo, L. P.; Bras, J.; Garcia, A.; Belgacem, N.; Curvelo, A. A. Subcritical water: a method for green production of cellulose nanocrystals. ACS Sustainable Chem. Eng. 2015, 3, 2839.
258. Wang, H.; Zhu, J. J.; Ma, Q.; Agarwal, U. P.; Gleisner, R.; Reiner, R.; Baez, C.; Zhu, J. Y. Pilot-Scale Production of Cellulosic Nanowhiskers With Similar Morphology to Cellulose Nanocrystals. Frontiers in Bioengineering and Biotechnology 2020, 8, 1070.
1. Reiner R S, Rudie A W. 1 Process Scale-Up of Cellulose Nanocrystal Production to 25 kg per Batch at the Forest Products Laboratory. In: Production and applications of Cellulose nanomaterials, TAPPI Press, Chapter 1.1, 2013; pp. 21-24. 2013; 1:21-4.
2. Dunlop M J, Acharya B, Bissessur R. Isolation of nanocrystalline cellulose from tunicates. Journal of Environmental Chemical Engineering. 2018 Aug. 1; 6 (4): 4408-12.
3. van den Berg O, Capadona J R, Weder C. Preparation of Homogeneous Dispersions of Tunicate Cellulose Whiskers in Organic Solvents. Biomacromolecules. 2007; 8 (4): 1353-7.
4. Cheryan M. Ultrafiltration and microfiltration handbook. CRC press; 1998.
5. Bercea M, Navard P. Shear Dynamics of Aqueous Suspensions of Cellulose Whiskers. Macromolecules. 2000 Aug. 1; 33 (16): 6011-6.
6. Agarwal U P, Ralph S A, Reiner R S, Hunt C G, Baez C, Ibach R, et al. Production of high lignin-containing and lignin-free cellulose nanocrystals from wood. Cellulose. 2018; 25 (10): 5791-805.
7. Agarwal U P, Reiner R S, Hunt C G, Catchmark J, Foster E J, Isogai A. Comparison of Cellulose Supramolecular Structures Between Nanocrystals of Different Origins. Proceedings of the 18th ISWFPC (International Symposium on Wood, Fiber, and Pulping Chemistry) held in Vienna (Sep. 9-11, 2015). 2015; pp. 6-9; 2015.
8. Chen W, Yu H, Liu Y, Chen P, Zhang M, Hai Y. Individualization of cellulose nanofibers from wood using high-intensity ultrasonication combined with chemical pretreatments. Carbohydrate Polymers. 2011; 83 (4): 1804-11.
9. Zhou L, He H, Li M, Huang S, Mei C, Wu Q. Enhancing mechanical properties of poly (lactic acid) through its in-situ crosslinking with maleic anhydride-modified cellulose nanocrystals from cottonseed hulls. Industrial Crops & Products. 2018 February; 112:449-59.
10. Park S H, Lee S G, Kim S H. The use of a nanocellulose-reinforced polyacrylonitrile precursor for the production of carbon fibers. J Mater Sci. 2013; 48 (20): 6952-9.
11. Kumar A. Characterization of cellulose nanocrystals produced by acid-hydrolysis from sugarcane bagasse as agro-waste. Mater Phys Chem. 2014; 2.
12. Cherian B M, Pothan L A, Nguyen-Chung T, Mennig G, Kottaisamy M, Thomas S. A Novel Method for the Synthesis of Cellulose Nanofibril Whiskers from Banana Fibers and Characterization. J Agric Food Chem. 2008 Jul. 1; 56 (14): 5617-27.
13. Alemdar A, Sain M. Isolation and characterization of nanofibers from agricultural residues-Wheat straw and soy hulls. Bioresource Technology. 2008; 99 (6): 1664-71.
14. Kumar A, Negi Y S, Choudhary V, Bhardwaj N K. Characterization of Cellulose Nanocrystals Produced by Acid-Hydrolysis from Sugarcane Bagasse as Agro-Waste.; 2014.
15. O'Connor R T, DuPré EF, Mitcham D. Applications of Infrared Absorption Spectroscopy to Investigations of Cotton and Modified Cottons: Part I: Physical and Crystalline Modifications and Oxidation. Textile Research Journal. 1958 May 1; 28 (5): 382-92.
16. Hurtubise F G, Krassig H. Classification of Fine Structural Characteristics in Cellulose by Infared Spectroscopy. Use of Potassium Bromide Pellet Technique. Anal Chem. 1960 Feb. 1; 32 (2): 177-81.
17. Nelson M L, O'Connor R T. Relation of certain infrared bands to cellulose crystallinity and crystal lattice type. Part II. A new infrared ratio for estimation of crystallinity in celluloses I and II. Journal of Applied Polymer Science. 1964; 8 (3): 1325-41.
18. Oh S Y, Yoo D I, Shin Y, Kim H C, Kim H Y, Chung Y S, et al. Crystalline structure analysis of cellulose treated with sodium hydroxide and carbon dioxide by means of X-ray diffraction and FTIR spectroscopy. Carbohydrate Research. 2005; 340 (15): 2376-91.
19. Sugiyama J, Persson J, Chanzy H. Combined infrared and electron diffraction study of the polymorphism of native celluloses. Macromolecules. 1991 Apr. 29; 24 (9): 2461-6.
20. Jiang F, Hsieh Y. Chemically and mechanically isolated nanocellulose and their self-assembled structures. Carbohydrate Polymers. 2013 Jun. 5; 95 (1): 32-40.
21. Roman M, Winter W T. Effect of Sulfate Groups from Sulfuric Acid Hydrolysis on the Thermal Degradation Behavior of Bacterial Cellulose. Biomacromolecules. 2004 Sep. 1; 5 (5): 1671-7.
22. Julien S, Chornet E, Overend R P. Influence of acid pretreatment (H2SO4, HCl, HNO3) on reaction selectivity in the vacuum pyrolysis of cellulose. Journal of Analytical and Applied Pyrolysis. 1993 Oct. 1; 27 (1): 25-43.
23. Beck S, Bouchard J. Auto-catalyzed acidic desulfation of cellulose nanocrystals. Nordic Pulp & Paper Research Journal. 2014; 29 (1): 6-14.
24. Wang N, Ding E, Cheng R. Thermal degradation behaviors of spherical cellulose nanocrystals with sulfate groups. Polymer. 2007 Jun. 4; 48 (12): 3486-93.
25. Li W, Wang R, Liu S. NANOCRYSTALLINE CELLULOSE PREPARED FROM SOFTWOOD KRAFT PULP VIA ULTRASONIC-ASSISTED ACID HYDROLYSIS. BioResources. 2011 Sep. 9; 6 (4): 4271-81.

1. A method for preparing tunicate derived nanocrystalline cellulose (tCNC), comprising:
collecting of or providing raw tunicate biomaterial;
fibrillating the tunicate biomaterial to form a crude tunic pulp;
deproteinating the crude tunic pulp under alkaline conditions with heating to solubilize said proteins, and then bleaching the deproteinated pulp;
separating the deproteinated tunic pulp from reaction solution by hot filtering;
adjusting pH of the filtered deproteinated tunic pulp to acid conditions, to produce a solid deproteinated and bleached tunic pulp, optionally with additional washing and hot filtering;
fibrillating the deproteinated and bleached tunic pulp to produce a wet cellulose pulp base material; and
hydrolyzing the wet cellulose pulp base material with a strong acid to produce said t-CNC.

2. The method according to claim 1, wherein the method further comprises a step of separating internal organs from the tunic of the raw tunicate biomaterial prior to said fibrillating; optionally wherein said separating step comprises mechanically pressing the raw tunicate biomaterial using a pressing device to loosen the tunic-organ connection within the tunicates.

3. The method of claim 2, wherein the step of separating internal organs from the tunic of the raw tunicate biomaterial comprises:
pressing the raw tunicate biomaterial prior to said fibrillating using a pressing device to rupture the tunic and loosen the connection with organ material; and optionally physically washing the pressed tunicate biomaterial;
stirring the pressed tunicate biomaterial in water for a time and at a speed effective to separate the tunic form the internal organs;
screening the stirred, pressed tunicate biomaterial to remove the water and produce separated tunic and organ components; and
collecting the tunic.

4. The method according to claim 1, wherein the separated tunic is fibrillated using a grinding mill, garburator or woodchipper.

5. The method according to claim 1, wherein the crude tunic pulp is deproteinated using an alkaline solution of NaOH, KOH or a mixture thereof and heating at from 50-75° C. for 1 to 24 hours, followed by said bleaching.

6. The method according to claim 5, wherein the alkaline solution comprises about 1.0-10.0 wt % NaOH, KOH or a mixture thereof.

7. (canceled)

8. The method according to claim 5, wherein the alkaline solution comprises about 4.0-5.0 wt % NaOH, KOH or a mixture thereof.

9. The method according to claim 1, wherein bleaching the deproteinated pulp is carried out by adding a bleach solution containing NaOCl with between 5 and 15% active chlorine and acetic acid at a concentration between 5 wt. % and 97 wt. %.

10. The method according to claim 1, wherein the hot filtering comprises filtering the deproteinated tunic pulp one or more times over a fiberglass screen mesh reinforced with a metal screen mesh.

11. The method according to claim 1, wherein the acid conditions are at or below pH 3.0.

12. The method according to claim 11, wherein the pH is adjusted using a strong acid.

13. The method according to claim 12 wherein the strong acid is sulfuric acid or hydrochloric acid.

14. The method according to claim 12 wherein the strong acid is at a concentration range of 1-10 wt. % acid.

15. The method according to claim 1, wherein the fibrillating of the deproteinated and bleached tunic pulp is carried out using a grinding mill or a garburator, to produce a fine pulp.

16. The method according to claim 15, wherein the fine pulp is a homogenous material where individual fibers can no longer be visually distinguished in the tunicate cellulose pulp.

17. The method according to claim 1, wherein the hydrolyzing comprises adding the strong acid to the wet cellulose pulp base material, mixing, quenching to neutralize the strong acid, allowing the resulting t-CNC to settle in solution, washing the settled solid t-CNC material, and then concentrating the washed T-CNCs to a final product.

18. Tunicate derived nanocrystalline cellulose (tCNC) prepared according to the method of claim 1.

19. A coating comprising a tunicate derived nanocrystalline cellulose (tCNC) prepared according to the method of claim 1.

20. An adhesive comprising a tunicate derived nanocrystalline cellulose (tCNC) prepared according to the method of claim 1.

21. A packaging material comprising a tunicate derived nanocrystalline cellulose (tCNC) prepared according to the method of claim 1.

22. (canceled)
